(19) United States
(12) Patent Application Publication
(10) Pub. No.: US 2023/0167525 A1
(43) Pub. Date: Jun. 1, 2023

(54) METHODS FOR RECOVERING A PRECIOUS METAL FROM REFRACTORY ORES BY NEAR-AMBIENT ALKALINE PRE-OXIDATION AND COMPLEXATION

(71) Applicant: COREM, Québec (CA)

(72) Inventors: Gnouyaro Palla ASSIMA, Québec, Québec (CA); Benoit LEVASSEUR, Québec, Québec (CA); Caroline OLSEN, Pont-Rouge, Québec (CA); Danielle DROLET, Québec, Québec (CA)

(73) Assignee: COREM, Québec, QC (CA)

(21) Appl. No.: 17/922,504

(22) PCT Filed: Apr. 30, 2021
(86) PCT No.: PCT/CA2021/050605

§ 371 Date: Oct. 31, 2022

Related U.S. Application Data
(60) Provisional application No. 63/018,882, filed on May 1, 2020.

(51) Int. Cl. C22B 11/08; C22B 3/12; C22B 3/22; C22B 3/44

(52) U.S. Cl. CPC C22B 11/08; C22B 3/12; C22B 3/22; C22B 3/44

(57) ABSTRACT

Methods for recovering gold from a refractory gold ore and concentrate are described. The method can include leaching the refractory gold ore and concentrate with the alkaline reagent under ambient or near-ambient conditions and a subsequent gold complexation. The method can optionally include separating a gold-containing leachate from a gold-unlocked solid residue obtained during the leaching step and performing a subsequent complexation on the gold-unlocked solid residue and optionally gold complexation on the gold-containing leachate. These methods can increase the gold recovery compared to conventional methods.

### RELATED APPLICATION

This application claims priority under applicable laws to U.S. provisional application No. 63/018,882 filed on May 1, 2020, the content of which is incorporated herein by reference in its entirety for all purposes.

### TECHNICAL FIELD

The technical field generally relates to methods for recovering at least one precious metal from ores including refractory ores, ore concentrates, or ore tailings which include at least one of arsenic, carbon, and sulfur and ores which are refractory to the recovery of precious metals.

### BACKGROUND

Refractory gold ores have increasingly been an important source of gold production with the exhaustion of free-milling gold deposits.

Gold ores are classified “free-milling” and “refractory” based on their response to cyanide dissolution. For instance, a gold recovery of 90% or more can be readily achieved with a conventional direct cyanidation and/or gravity concentration of free-milling ores. In contrast, ores whose gold recovery performances are below 90% are called refractory ores (Zhou, J., et al. “Establishing the process mineralogy of gold ores.” Technical bulletin (2004): 03).

Gold recovery is negatively affected by the presence of arsenic, organic carbon, and/or sulfur. For example, the gold in refractory ores can be associated with and encapsulated within oxidizable gangue such as sulfide minerals, carbonaceous materials and/or non-oxidizable matrix (silicates), or associated with carbonaceous matter capable of adsorbing gold from alkaline cyanide solution (e.g. heavy hydrocarbons, humic acid, or elemental carbon) via a phenomenon known as preg-robbing, and/or can be a solid solution with highly reactive minerals (e.g. pyrrhotite, arsenopyrite, or copper oxide). It is often referred to the presence of two or three of the above-mentioned categories in the same ore as double or triple refractory ores. For example, double refractory ores can include gold encapsulated within sulfide minerals and gold preg-robbing due to the presence of organic carbon.

It is a well known that refractory ores can be challenging to process, for instance, they can require treatment processes for the cyanidation process to be effective in recovery of the gold. Various treatment processes have been proposed increase gold recovery from refractory ores. These treatment processes can include, for example, mechanical pre-treatments (e.g., grinding), oxidative pre-treatments (e.g., pressure oxidation, wet pressure oxidation, roasting oxidation, and biological oxidation, and chemical oxidation), gravity separation, carbon flotation, roasting, carbon-in-leach separation, carbon-in-pulp separation and passivation or deactivation of the preg-robbing material.

Although these treatments generate a great deal of interest because of their efficiency when compared to more conventional gold cyanidation, they are still limited by several factors, such as extraction efficiency, the need for high pressure and/or high temperature equipment, energy consumption, costs, and negative environmental impacts.

Accordingly, many challenges still exist and there is a need for new methods that can overcome one or more of the disadvantages encountered with the use of conventional methods for recovering precious metals from refractory ores.

### SUMMARY

According to one aspect, the present technology relates to a method for recovering gold from a refractory gold ore, the method comprising the steps of:
leaching the refractory gold ore with an alkaline reagent under atmospheric pressure, at a temperature below the boiling point, and in the presence of an oxidant to obtain a refractory gold ore mixture including a gold-containing leachate and a gold-unlocked solid residue;
separating the gold-containing leachate from the gold-unlocked solid residue;
mixing at least the gold-unlocked solid residue with a gold complexing agent to form a soluble gold-containing complex; and
recovering gold from the gold-containing complex.

In one embodiment, the method further comprises mixing at least the gold-containing leachate with the gold complexing agent

In another embodiment, the refractory gold ore includes a sulfide mineral, or an arsenic sulfide mineral selected from the group consisting of arsenopyrite, pyrite, tetrahedrite, pyrrhotite, marcasite, chalcopyrite, stibnite, and a combination of at least two thereof.

In another embodiment, the alkaline reagent is selected from the group consisting of calcium carbonate, sodium carbonate, calcium hydroxide, sodium hydroxide, and a mixture of at least two thereof.

In another embodiment, the oxidant is selected from the group consisting of air, oxygen, ozone, peroxide, iron oxide, perchlorates, and a mixture of at least two thereof.

In another embodiment, the leaching step is carried out at ambient temperature.

In another embodiment, the leaching step is carried out at a temperature in the range of from about 10° C. to about 100° C., or from about 10° C. to about 95° C., or from 10° C. to about 90° C., or from about 10° C. to about 85° C., or from about 10° C. to about 80° C., or from about 10° C. to about 70° C., or from about 10° C. to about 60° C., or from about 40° C. to about 100° C., or from about 40° C. to about 95° C., or from about 40° C. to about 90° C., or from about 40° C. to about 85° C., or from about 40° C. to about 80° C., or from about 40° C. to about 70° C., or from about 40° C. to about 60° C.

In another embodiment, the step of separating the gold-containing leachate from the gold-unlocked solid residue is performed by thickening or filtration.

In another embodiment, the method further comprises adding a surfactant to the gold-unlocked solid residue prior to the mixing step.

In another embodiment, the gold complexing agent is selected from the group consisting of cyanide salts, thiocyanate salts, thiourea salts, thiocyanate salts, ammonium salts, halide salts, and a combination of at least two thereof.

In another embodiment, the method further comprises recovering the gold-containing complex by adsorption on an absorbent.

In another embodiment, the method further comprises comminuting the refractory gold ore to obtain refractory gold ore particles having a predetermined size.

According to another aspect, the present technology relates to a method for recovering gold from a refractory gold ore being subject to sulfide locking, the method comprising the steps of:
leaching the refractory gold ore with an alkaline reagent under atmospheric pressure, at a temperature above 40° C. and in the presence of an oxidant to produce at least one metal thiosulfate and obtain a refractory gold ore mixture including a gold-containing leachate and a gold-unlocked solid residue;
mixing at least the gold-unlocked solid residue with a gold complexing agent to form a soluble gold-containing complex; and
recovering gold from the gold-containing complex.

In one embodiment, the method further comprises separating the gold-containing leachate from the gold-unlocked solid residue.

In another embodiment, the method further comprises mixing at least the gold-containing leachate with the gold complexing agent.

In another embodiment, the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

In another embodiment, the alkaline reagent is selected from the group consisting of calcium carbonate, sodium carbonate, calcium hydroxide, sodium hydroxide, and a mixture of at least two thereof.

In another embodiment, the oxidant is selected from the group consisting of air, oxygen, ozone, peroxide, iron oxide, perchlorates, and a mixture of at least two thereof.

In another embodiment, the method further comprises adding a surfactant to refractory gold ore mixture or to the gold-unlocked solid residue prior to the mixing step.

In another embodiment, the step of separating the gold-containing leachate from the gold-unlocked solid residue is performed by thickening or filtration.

In another embodiment, the gold complexing agent is selected from the group consisting of cyanide salts, thiocyanate salts, thiourea salts, thiocyanate salts, ammonium salts, halide salts, and a combination of at least two thereof.

In another embodiment, the method further comprises recovering the gold-cyanide complex by adsorption on an absorbent.

In another embodiment, the method further comprises comminuting the refractory gold ore to obtain refractory gold ore particles having a predetermined size.

According to another aspect, the present technology relates to a method for recovering gold from a refractory gold ore, the method comprising the steps of:
concentrating the refractory gold ore to obtain a refractory gold ore concentrate comprising at least 0.1 wt. % of organic carbon or arsenic;
leaching the refractory gold ore concentrate with an alkaline reagent under atmospheric pressure, at a temperature below the boiling point, and in the presence of an oxidant to obtain a refractory gold ore concentrate mixture including a gold-containing leachate and a gold-unlocked solid residue;
mixing at least the gold-unlocked solid residue with a gold complexing agent to form a soluble gold-containing complex; and
recovering gold from the gold-containing complex.

In one embodiment, the method further comprises separating the gold-containing leachate from the gold-unlocked solid residue.

In another embodiment, the method further comprises mixing at least the gold-containing leachate with the gold complexing agent.

In another embodiment, the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

In another embodiment, the concentrating step is performed by flotation.

In another embodiment, the gold ore concentrate comprises at least 5 wt. % of organic carbon or arsenic.

In another embodiment, the alkaline reagent is selected from the group consisting of calcium carbonate, sodium carbonate, calcium hydroxide, sodium hydroxide, and a mixture of at least two thereof.

In another embodiment, the oxidant is selected from the group consisting of air, oxygen, ozone, peroxide, iron oxide, perchlorates, and a mixture of at least two thereof.

In another embodiment, the method further comprises adding a surfactant to refractory gold ore mixture or to the gold-unlocked solid residue prior to the mixing step.

In another embodiment, the step of separating the gold-containing leachate from the gold-unlocked solid residue is performed by thickening or filtration.

In another embodiment, the gold complexing agent is selected from the group consisting of cyanide salts, thiocyanate salts, thiourea salts, thiocyanate salts, ammonium salts, halide salts, and a combination of at least two thereof.

In another embodiment, the method further comprises recovering the gold-cyanide complex by adsorption on an absorbent.

In another embodiment, the method further comprises comminuting the refractory gold ore to obtain refractory gold ore particles having a predetermined size.

In another embodiment, the method further comprises comminuting the refractory gold ore concentrate to obtain refractory gold ore concentrate particles having a predetermined size.

According to another aspect, the present technology relates to a method for recovering gold from a refractory gold ore, the method comprising the steps of:
comminuting the refractory gold ore in the presence of an alkaline reagent and an oxidant under atmospheric pressure to obtain refractory gold ore particles;
concentrating the oxidized refractory gold ore particles to obtain refractory gold ore concentrate particles;
leaching the refractory gold ore concentrate particles with the alkaline reagent under atmospheric pressure, at a temperature below the boiling point, and in the presence of the oxidant to obtain a refractory gold ore concentrate mixture including a gold-containing leachate and a gold-unlocked solid residue;
mixing at least the gold-unlocked solid residue with a gold complexing agent to form a soluble gold-containing complex; and
recovering gold from the gold-containing complex.

In one embodiment, the method further comprises separating the gold-containing leachate from the gold-unlocked solid residue.

In another embodiment, the method further comprises mixing at least the gold-containing leachate with the gold complexing agent.

In another embodiment, the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

In another embodiment, the gold-containing leachate comprises arsenic.

In another embodiment, the concentrating step is performed by flotation.

In another embodiment, the refractory gold ore concentrate comprises at least 0.1 wt. % of organic carbon or arsenic.

In another embodiment, the alkaline reagent is selected from the group consisting of calcium carbonate, sodium carbonate, calcium hydroxide, sodium hydroxide, and a mixture of at least two thereof.

In another embodiment, the oxidant is selected from the group consisting of air, oxygen, ozone, peroxide, iron oxide, perchlorates, and a mixture of at least two thereof.

In another embodiment, the method further comprises adding a surfactant to refractory gold ore mixture or to the gold-unlocked solid residue prior to the mixing step.

In another embodiment, the gold complexing agent is selected from the group consisting of cyanide salts, thiocyanate salts, thiourea salts, thiocyanate salts, ammonium salts, halide salts, and a combination of at least two thereof.

In another embodiment, the method further comprises recovering the gold-cyanide complex by adsorption on an absorbent.

According to another aspect, the present technology relates to a method recovering gold from a refractory gold ore including sulfide mineral or an arsenic sulfide mineral, the method comprising the steps of:
contacting the refractory gold ore with a metal hydroxide added in an amount of hydroxide up to about 4 equivalents per equivalent of sulfur contained in the refractory gold ore;
leaching the refractory gold ore with the metal hydroxide under atmospheric pressure, at a temperature in the range of from about 40° C. to about 80° C. and in the presence of an oxidant added at a flow rate inferior to about 144 L/h/kg to produce at least one metal thiosulfate and obtain a refractory gold ore mixture including a gold-containing leachate and a gold-unlocked solid residue;
mixing at least the gold-unlocked solid residue with a gold complexing agent to form a soluble gold-containing complex; and
recovering gold from the gold-containing complex.

In one embodiment, the method further comprises separating the gold-containing leachate from the gold-unlocked solid residue.

In another embodiment, the method further comprises mixing at least the gold-containing leachate with the gold complexing agent.

In another embodiment, the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

In another embodiment, the metal of the metal hydroxide is selected from the group consisting of alkali metals and alkaline earth metals. In some example, the metal hydroxide is sodium hydroxide or calcium hydroxide.

In another embodiment, the amount of hydroxide is in the range of from about 1 equivalent to about 4 equivalents, or from about 1 equivalent to about 3 equivalents, or from about 1.5 equivalents to about 2.5 equivalents per equivalent of sulfur contained in the refractory gold ore.

In another embodiment, the oxidant is selected from the group consisting of air, oxygen, ozone, peroxide, iron oxide, perchlorates, and a mixture of at least two thereof.

In another embodiment, the oxidant is added at a flow rate inferior to about 132 L/h/kg, or inferior to about 120 L/h/kg, or inferior to about 108 L/h/kg, or inferior to about 96 L/h/kg, or inferior to about 84 L/h/kg, or inferior to about 72 L/h/kg, or inferior to about 60 L/h/kg, or inferior to about 48 L/h/kg.

In another example, the leaching step is carried out at a temperature in the range of from about 45° C. to about 75° C., or from about 50° C. to about 70° C., or from about 55° C. to about 65° C.

In another embodiment, the method further comprises adding a surfactant to refractory gold ore mixture or to the gold-unlocked solid residue prior to the mixing step.

In another embodiment, the gold complexing agent is selected from the group consisting of cyanide salts, thiocyanate salts, thiourea salts, thiocyanate salts, ammonium salts, halide salts, and a combination of at least two thereof.

In another embodiment, the method further comprises recovering the gold-cyanide complex by adsorption on an absorbent.

### BRIEF DESCRIPTION OF DRAWINGS

FIG. 1 is a flow diagram of a process for recovering gold from refractory gold ores according to one embodiment.

FIG. 2 is a flow diagram of a process for recovering gold refractory gold ores according to another embodiment.

FIG. 3 is a flow diagram of a process for recovering gold from refractory gold ores according to another embodiment.

FIG. 4 is a flow diagram of a process for recovering gold refractory gold ores according to another embodiment.

FIG. 5 is a flow diagram of a process for recovering gold from refractory gold ores according to another embodiment.

FIG. 6 is a flow diagram of a process for recovering gold from refractory gold ores according to another embodiment.

FIG. 7 is a flow diagram of a process for recovering gold from refractory gold ores according to another embodiment.

FIG. 8 is a grouped bar chart presenting the quantification of oxidized sulfur (%) as a function of three different temperatures (40° C., 60° C. and 80° C.) and three different NaOH concentrations (6 wt. %, 8 wt. % and 10 wt. %), as described in Example 2(a).

FIG. 9 is a grouped bar chart presenting the quantification of leached arsenic (%) as a function of three different temperatures (40° C., 60° C. and 80° C.) and three different NaOH concentrations (6 wt. %, 8 wt. % and 10 wt. %), as described in Example 2(a).

FIG. 10 is a graph of the gold in solution (mg/L) as a function of time (hours), as described in Example 2(b).

FIG. 11 is a graph of concentration of thiosulfate (mg/L) versus time (days) for the first (NAAO #1; blue line), the second (NAAO #2; red line), the third (NAAO #3; grey line), and the fourth (NAAO #4; green line) tanks, as described in Example 3(c). The dotted line represents a change in operating conditions.

FIG. 12 is a graph of the concentration of gold leached at the NAAO step (mg/L) versus time (days) for the first (NAAO #1; blue line), the second (NAAO #2; orange line), the third (NAAO #3; grey line), and the fourth (NAAO #4; green line) tanks, as described in Example 3(c). The dotted line represents a change in operating conditions.

FIG. 13 is a graph of the percentage of gold leached (%) versus time (days) recorded for the cyanide leaching process (CN leaching; green line), for the NAAO leaching process (NAAO leaching; red line), and for the global recovery process (Global leaching; black line), as described in Example 3(c). The dotted line represents a change in operating conditions.

FIG. 14 is a graph of the sodium cyanide (NaCN) consumption (kg/t) versus time (days), as described in Example 3(c). The dotted line represents a change in operating conditions.

### DETAILED DESCRIPTION

The following detailed description and examples are illustrative and should not be interpreted as further limiting the scope of the invention. On the contrary, it is intended to cover all alternatives, modifications and equivalents that can be included as defined by the present description. The objects, advantages and other features of the methods will be more apparent and better understood upon reading the following non-restrictive description and references made to the accompanying drawings.

Where applicable, although process flow diagrams may be used to describe embodiments, the invention is not limited to those diagrams or to the corresponding descriptions. Furthermore, for the sake of simplicity and clarity, namely so as to not unduly burden the figures with steps, reactants and/or products, not all figures contain all the steps, reactants and/or products. Some steps, reactants and/or products may be found in only one figure, and steps, reactants and/or products of the present disclosure which are illustrated in other figures can be easily inferred therefrom.

All technical and scientific terms and expressions used herein have the same definitions as those commonly understood by the person skilled in the art when relating to the present technology. The definition of some terms and expressions used herein is nevertheless provided below for clarity purposes.

When the term “about” is used herein, it means approximately, in the region of, or around. When the term “about” is used in relation to a numerical value, it modifies it; for example, by a variation of 10% above and below its nominal value. This term can also take into account the rounding of a number or the probability of random errors in experimental measurements; for instance, due to equipment limitations.

When a range of values is mentioned in the present application, the lower and upper limits of the range are, unless otherwise indicated, always included in the definition. When a range of values is mentioned in the present application, then all intermediate ranges and subranges, as well as individual values included in the ranges, are intended to be included.

When the term “equilibrium” is used herein, it refers to a steady state in which the stated variable has no observable impact (or no net impacts) on the properties of the system, although the ongoing process strives to change it.

As used herein, the expression “refractory ore” refers to an ore which is less than 90% amenable to gold extraction by standard cyanidation leaching techniques. The expression “refractory ore” encompass mildly, moderately, and highly refractory ores which are respectively between 80% and 90%, between 50% and 80%, and less than 50% amenable to gold extraction by standard cyanidation leaching techniques. The expression “refractory ore” also includes ore concentrates and ore tailings which are less than 90% amenable to gold extraction by standard cyanidation leaching techniques.

As used herein, the expression “gold complexation” refers to the conversion of gold comprised in a leachate to a gold-containing complex. The expression “cyanide complexation” refers to the conversion of gold comprised in a leachate to a gold-cyanide complex, or to a common gold cyanidation process also referred to as a cyanide process or a MacArthur-Forrest process.

It is worth mentioning that throughout the following description when the article “a” is used to introduce an element, it does not have the meaning of “only one” and rather means “one or more”. It is to be understood that where the specification states that a step, component, feature, or characteristic “may”, “might”, “can” or “could” be included, that particular component, feature or characteristic is not required to be included in all alternatives. When the term “comprising” or its equivalent terms “including” or “having” are used herein, it does not exclude other elements. If a group is defined hereinafter to include at least a certain number of embodiments, it is also to be understood to disclose a group, which preferably consists only of these embodiments.

The present technology relates to methods for recovering at least one precious metal from refractory ores and refractory concentrates, and more particularly, to methods for recovering gold from refractory gold ores and refractory concentrates. The method includes an alkaline oxidative leaching pre-treatment step followed by a gold complexation step.

The refractory gold ore can be, for example, a simple, double, or even a triple refractory gold ore. For example, a double refractory gold ore includes gold particles locked within sulfide minerals and preg-robbing due to the presence of organic carbon. The refractory gold ore can include at least one of sulfide minerals, a carbonaceous material, a non-oxidizable matrix, and reactive minerals. The refractory gold ore can include sulfide minerals and/or arsenic sulfide minerals.

For example, the sulfide mineral and/or arsenic sulfide minerals can be selected from the group consisting of arsenopyrite, pyrite, tetrahedrite, pyrrhotite, marcasite, chalcopyrite, stibnite, and combinations thereof. In one variant of interest, the refractory gold ore includes pyrite, arsenopyrite and pyrrhotite. In another variant of interest, the refractory gold ore includes pyrite, pyrrhotite, arsenopyrite, stibnite, and chalcopyrite.

The refractory gold ore can have a grade of at least about 0.1 gram of gold per ton of dry refractory gold ore. For example, the refractory gold ore can have a gold grade in the range of from about 0.1 g/t to about 30 g/t, limits included.

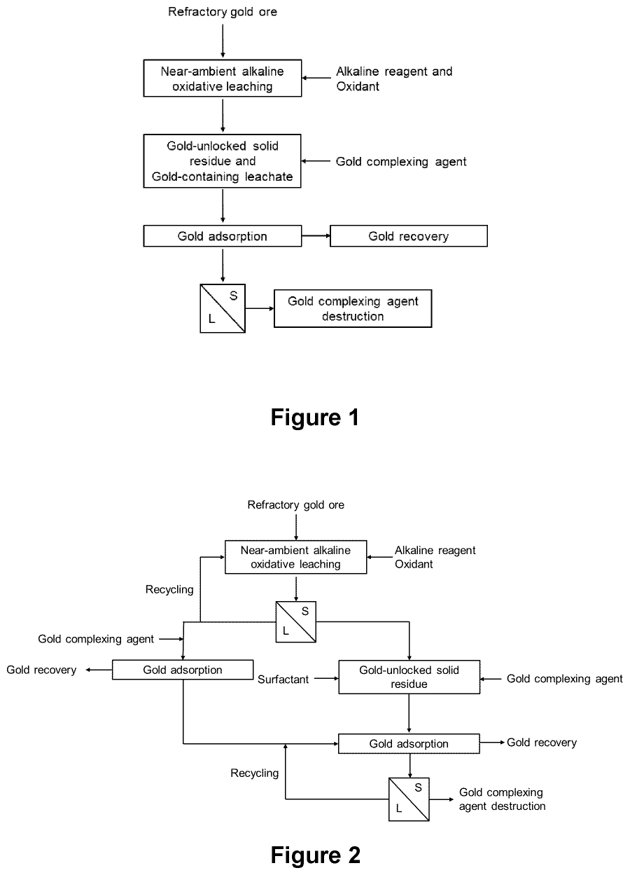

For a more detailed understanding of the disclosure, reference is first made to FIG. 1, which provides a flow diagram of a method for recovering gold from refractory gold ores in accordance with a possible embodiment.

As illustrated in FIG. 1, the method for recovering gold from refractory gold ores includes an alkaline oxidative leaching step and a subsequent gold complexation step.

The alkaline oxidative leaching step can be performed in order to completely or partially oxidize sulfur and/or dissolve the arsenic present in the refractory gold ore in order to render the gold substantially more amenable to complexation, thereby substantially improving the gold-containing complex leaching rate.

In some examples, the alkaline oxidative leaching step can be substantially free of added gold complexing agent (e.g., cyanide) to substantially reduce or completely avoid preg-robbing at this stage of the process. In one variant of interest, the alkaline oxidative leaching step is completely free of added gold complexing agent.

The alkaline oxidative leaching step is performed by mixing the refractory gold ore with at least one alkaline reagent (or alkaline lixiviant) in the presence of at least one oxidant to obtain a refractory gold ore mixture including a gold-containing leachate and a gold-unlocked solid residue.

For example, any compatible alkaline reagent is contemplated. Non-limiting examples of alkaline reagent include alkali and alkali earth metal basic salts, oxides and hydroxides, and mixtures thereof. For example, the alkaline reagent includes at least one of calcium carbonate (CaCO₃), sodium carbonate (Na₂CO₃), calcium hydroxide (Ca(OH)₂), and sodium hydroxide (NaOH). In one variant of interest, the alkaline reagent is sodium hydroxide (NaOH).

Any compatible oxidant is also contemplated. Examples of suitable oxidant include, but are not limited to air, oxygen, ozone, peroxide, iron oxide, perchlorates, and combinations thereof. In one variant of interest, the oxidant is oxygen.

In some examples, the oxidant is added at a flow rate inferior to about 144 L/h/kg. For example, the oxidant is added at a flow rate inferior to about 132 L/h/kg, or inferior to about 120 L/h/kg, or inferior to about 108 L/h/kg, or inferior to about 96 L/h/kg, or inferior to about 84 L/h/kg, or inferior to about 72 L/h/kg, or inferior to about 60 L/h/kg, or inferior to about 48 L/h/kg. In one variant of interest, the oxidant is added at a flow rate inferior to about 48 L/h/kg.

The alkaline reagent can be added in an amount sufficient to obtain a pH in the range of from about 8 to about 14, preferably a pH of at least 12, or more preferably a pH of at least 13. For example, the pH is maintained during the gold complexation step. In one variant of interest, the alkaline reagent is added in an amount sufficient to obtain a pH of about 10.5.

In some examples, the refractory gold ore mixture includes less than about 30 wt. %, or less than about 25 wt. %, or less than about 20%, or less than about 15 wt. % of the alkaline reagent. For example, the refractory gold ore mixture includes from about 0.5 wt. % to about 30 wt. %, or from about 0.5 wt. % to about 25 wt. %, or from about 0.5 wt. % to about 20 wt. %, or from about 0.5 wt. % to about 15 wt. %, or from about 0.5 wt. % to about 10 wt. %, or from about 1 wt. % to about 10 wt. %, or from about 2 wt. % to about 10 wt. %, or from about 3 wt. % to about 10 wt. %, or from about 4 wt. % to about 10 wt. %, or from about 5 wt. % to about 10 wt. %, or from about 6 wt. % to about 10 wt. % of the alkaline reagent, limits included.

In some examples, the refractory gold ore can include a sulfide mineral or an arsenic sulfide mineral and the alkaline reagent is a metal hydroxide added so that the amount of hydroxide is up to about 4 equivalents per equivalent of sulfur contained in the refractory gold ore. For instance, the amount of hydroxide is in the range of from about 1 equivalent to about 4 equivalents per equivalent of sulfur contained in the refractory gold ore, limits included. For example, the amount of hydroxide is in the range of from about 1 equivalent to about 3.5 equivalents, or from about 1 equivalent to about 3 equivalents, or from about 1 equivalent to about 2.5 equivalents, or from about 1.5 equivalents to about 2.5 equivalents per equivalent of sulfur contained in the refractory gold ore, limits included. In one variant of interest, the amount of hydroxide is of about 2 equivalents per equivalent of sulfur contained in the refractory gold ore. The metal of the metal hydroxide can be an alkali and alkali earth metal, for example, the metal hydroxide can be sodium hydroxide or calcium hydroxide. In one variant of interest, the refractory gold includes pyrite or arsenopyrite and the metal hydroxide is added so that the amount of hydroxide is of about 2 equivalents per equivalent of sulfur contained in the refractory gold ore.

The alkaline oxidative leaching step is carried out under atmospheric pressure or near-atmospheric and under either ambient or near-ambient conditions (i.e., at atmospheric pressure, and either at ambient temperature or a near-ambient temperature).

In some example, the alkaline oxidative leaching step is a near-ambient alkaline oxidative (NAAO) leaching step (i.e. carried out at atmospheric pressure, and at a near-ambient temperature). The NAAO leaching step can be carried out at a temperature at ambient temperature or at a moderately elevated temperature (below the boiling point of the refractory gold ore mixture). For example, the NAAO leaching step can be carried out at a temperature in the range of from about 10° C. to about 100° C., or from about 10° C. to about 95° C., or from 10° C. to about 90° C., or from about 10° C. to about 85° C., or from about 10° C. to about 80° C., or from about 10° C. to about 70° C., or from about 10° C. to about 60° C., or from about 40° C. to about 100° C., or from about 40° C. to about 95° C., or from about 40° C. to about 90° C., or from about 40° C. to about 85° C., or from about 40° C. to about 80° C., or from about 40° C. to about 70° C., or from about 40° C. to about 60° C., limits included. In one variant of interest, the NAAO leaching step is carried out at a temperature in the range of from about 40° C. to about 80° C.

In some examples, the alkaline oxidative leaching step is carried out until the system reaches equilibrium. For instance, the alkaline oxidative leaching step is carried out for a time period of less than about 96 hours. For example, the alkaline oxidative leaching step is carried out for a time period in the range of from about 8 hours to about 96 hours, or from about 12 hours to about 96 hours, or from about 24 hours to about 96 hours, or from about 48 hours to about 96 hours, or from about 72 hours to about 96 hours, limits included.

In some example, the gold-unlocked solid residue has a percentage of solid in the range of from about 35 wt. % to about 85 wt. %, or from about 40 wt. % to about 85 wt. %, or from 50 wt. % to about 85 wt. %, or from about 60 wt. % to about 85 wt. %, or from about 70 wt. % to about 85 wt. %, limits included.

In some example, the method optionally includes at least one concentration step which can be performed, for example, by flotation or by gravity separation.

In some examples, the method optionally includes a comminution step or a size reduction step (not shown in FIG. 1) to obtain refractory gold ore particles having a predetermined size. For example, any compatible comminution method is contemplated. The comminution step can be performed by at least one of crushing, grinding, cutting, and other similar processes. For instance, the comminution step can be performed by milling, and preferably by ball milling or by stirred milling using a Stirred Media Detritor (SMD) such as a VXPmill™, a Vertimill™ or any other compatible stirred mill. The method can also further include classifying and separating the refractory gold ore particles by size into fractions. For example, the refractory gold ore particles can be screened and classified into narrow sized fractions to obtain refractory gold ore particles having a size of less than about 300 μm.

In some examples, the refractory gold ore particles are substantially uniform in size. For instance, the refractory gold ore particles have a size suitable to facilitate liberation of gold from the refractory gold ore. For example, the refractory gold ore particles can have a diameter in the range of from about 1 μm to about 300 μm, or from about 1 μm to about 100 μm, or from about 1 μm to about 75 μm, or from about 1 μm to about 60 μm, or from about 1 μm to about 50 μm, or from about 1 μm to about 40 μm, or from about 1 μm to about 30 μm, or from about 1 μm to about 25 μm, limits included.

In cases where the method includes a comminution step, the comminution and alkaline oxidative leaching steps can be performed sequentially, simultaneously, or partially overlapping in time with each other.

In some examples, the comminution and alkaline oxidative leaching steps are performed sequentially, and the comminution step is performed before the alkaline oxidative leaching step.

In some other examples, the comminution and alkaline oxidative leaching steps are performed partially overlapping in time with each other. For instance, a first amount of the alkaline reagent can be added to the refractory gold ore particles during the comminution step and a second amount of the alkaline reagent can be added in a subsequent alkaline oxidative leaching step. For example, from about 0.5 wt. % to about 10 wt. % of the alkaline reagent can be added during the comminution step and a second amount can be added during the following alkaline oxidative leaching step. Preferably, the first and second amounts are substantially similar. It is to be understood that the alkaline reagent is added in the presence of an oxidant as defined herein.

The method optionally includes mixing the refractory gold ore particles or the gold-unlocked solid residue with water (not shown in FIG. 1) to produce a refractory gold ore slurry or pulp or a gold-unlocked solid residue slurry or pulp.

Now referring to FIG. 2, the method can further include separating the gold-containing leachate from the gold-unlocked solid by a solid-liquid separation process. For example, any compatible solid-liquid separation process is contemplated. In some variants of interest, the solid-liquid separation process can be performed by thickening and/or filtration using any standard techniques known in the art.

In some example, the refractory gold ore mixture can include a solid content in the range of from about 25 wt. % to about 60 wt. %, limits included. For example, the refractory gold ore mixture can include a solid content of less than 60 wt. %, or less than 50 wt. %, or less than 40 wt. %, or less than 30 wt. %, or less than 25 wt. %. In one variant of interest, the oxidized refractory gold ore can be thickened to obtain a solid concentration of about 25 wt. %.

Referring back to FIG. 1, the method further includes a gold complexation step performed by mixing at least one of the gold-containing leachate and the gold-unlocked solid residue with a gold complexing agent to form at least one soluble gold-containing complex.

Any known compatible gold complexing agent is contemplated, for example, compatible gold complexing agents include cyanides, thiocyanates, thioureas, thiocyanates, ammonia, halide (e.g., chloride, bromide, and iodide), a salt thereof, a combination of at least two thereof when applicable and other similar complexing agents. For example, the gold complexing agent can be a cyanide salt. Non-limiting examples of cyanide salts include sodium cyanide, potassium cyanide and calcium cyanide. In one variant of interest, the gold complexing agent is sodium cyanide.

In some examples, the gold complexation step is performed under alkaline conditions, for example, at a pH as defined above.

The gold complexation step can be carried out until the system reaches equilibrium. For instance, the gold complexation step can be carried out for a time period of less than about 96 hours. For example, the gold complexation step can be carried out for a time period in the range of from about 8 hours to about 96 hours, or from about 12 hours to about 96 hours, or from about 24 hours to about 96 hours, or from about 48 hours to about 96 hours, or from about 72 hours to about 96 hours limits included.

Still referring to FIG. 1, the method further includes a gold adsorption step. For example, the gold adsorption and gold complexation steps can be performed sequentially, simultaneously, or partially overlapping in time with each other, and preferably simultaneously. Any compatible gold adsorption method is contemplated, for example, the gold adsorption step can be performed by contacting the gold-containing leachate or the gold-unlocked solid residue with an adsorbent for gold recovery. Any known compatible adsorbent is contemplated, for example, compatible adsorbents include activated carbon and resin beads such as polystyrene-based resin beads. In one variant of interest, the adsorbent is activated carbon. For example, the gold adsorption step can be performed by a method selected from carbon-in-leach (CIL), carbon-in-pulp (CIP), carbon-in-columns (CIC), resin-in-leach (RIL) and resin-in-pulp (RIP). In one variant of interest, the gold adsorption step is performed by the CIL method. For example, during the gold adsorption step, the gold-containing complex can adsorb on the adsorbent. The gold adsorption step can be carried out until the system reaches equilibrium. The method can further include retrieving the adsorbent with the gold-containing complex adsorbed thereon, for example, by screening.

In some example, a surfactant can be optionally added to the gold-unlocked solid residue prior to the gold adsorption step. For instance, the surfactant can be any compatible carbon blanking reagent used in gold leaching processes to prevent preg-robbing by carbonaceous or graphitic material. For example, the surfactant can be Dehscofix™ DG 30.

In some example, gold can be recovered by desorbing the gold-containing complex from the adsorbent, for example, at elevated temperature and pH.

In cases where the refractory gold ore includes arsenic, at least a portion of the arsenic can be dissolved in the alkaline oxidative leaching step and thereby be included in the gold-containing leachate. For instance, the gold-containing leachate can also comprise arsenic. In such cases, extractive recovery and valorisation of arsenic can be performed, for example, via precipitation or crystallization by the addition of ferric salts, calcium oxide, or any other compatible chemical compounds known in the field.

In some example, the method can also optionally include recycling and/or reusing at least a portion of the alkaline reagent, the gold complexing agent, and/or the adsorbent.

In some example, the method can also optionally include detoxifying the tailing from the gold complexation step. The detoxification step can be performed to substantially reduce the concentration of residual gold complexing agent, for instance, to reduce the concentration of residual cyanide.

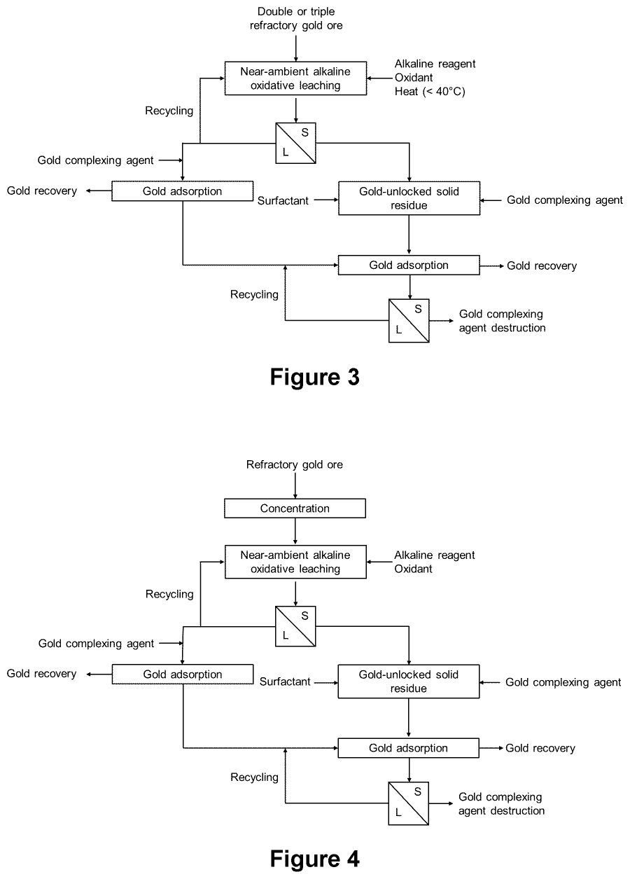

In at least one embodiment, the refractory ore is a double or a triple refractory ore including arsenic and/or gold being subject to sulfide locking, and reference is now made to FIG. 3, which provides a flow diagram of a method for recovering gold from a double or triple refractory gold ore.

In some example, the refractory ore is a double or a triple refractory ore can include carbonaceous matter which can lead to gold adsorption on carbonaceous matter.

As illustrated in FIG. 3, the alkaline oxidative leaching step of the method as described herein is carried out under near ambient conditions and at a temperature above 40° C. It is to be understood that said temperature is below the boiling point of the refractory gold ore mixture. For example, the alkaline oxidative step can be is carried out at a temperature in the range of from 40° C. to 100° C., or from 40° C. to 90° C., or from 40° C. to 80° C., or from 40° C. to 70° C.

As illustrated in FIG. 4, in at least one embodiment, the method as described herein comprises a concentration step which can be performed, for example, by flotation. The refractory gold ore concentrate obtained in the concentration can have an organic carbon or arsenic content of at least about 0.1 wt. %. For example, the organic carbon or arsenic content of the refractory gold ore concentrate can be of at least about 1 wt. %, or at least about 5 wt. %, or at least about 10 wt. %, or at least about 15 wt. %. For example, the organic carbon or arsenic content of the refractory gold ore concentrate can be in the range of from about 0.1 wt. % to about 30 wt. %, or from about 1 wt. % to about 30 wt. %, or from about 2 wt. % to about 30 wt. %, or from about 5 wt. % to about 30 wt. %, or from about 8 wt. % to about 30 wt. %, or from about 10 wt. % to about 30 wt. %, or from about 15 wt. % to about 30 wt. %, or from about 15 wt. % to about 25 wt. %, limits included.

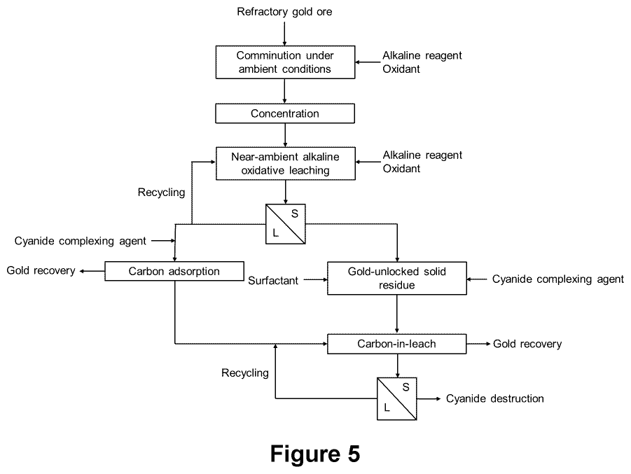

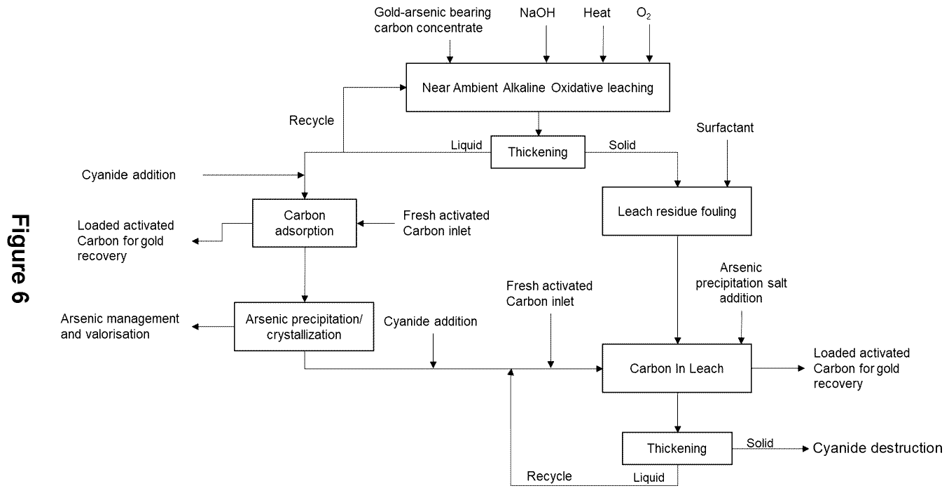

As illustrated in FIG. 5, in at least one embodiment, the method as described herein comprises both a size reduction step and a concentration step. The comminution is carried out under ambient conditions (i.e., at normal atmospheric pressure and at ambient temperature) and in the presence of both the alkaline reagent and the oxidant. The concentration can be performed, for example, by flotation or by gravity separation.

### EXAMPLES

The following non-limiting examples are illustrative embodiments and should not be construed as limiting the scope of the present invention. These examples will be better understood with reference to the accompanying Figures.

### Example 1: Gold Recovery from Refractory Ores and Refractory Concentrates

(a) Gold Recovery from Gold-Arsenic-Bearing Refractory Carbon Concentrates

For a more detailed understanding of the disclosure, reference is now made to FIG. 6, which provides a flow diagram of a method for recovering gold from a gold-arsenic-bearing carbon concentrate pulp in accordance with a possible embodiment.

As illustrated in FIG. 6, a multistep leaching process was performed on gold-arsenic-bearing carbon concentrate samples to release and extract gold entwisted in arsenic-bearing sulfide minerals. The chemical composition of the gold-arsenic-bearing carbon concentrate samples is presented in Table 1.

TABLE 1
Chemical composition of the gold-arsenic-bearing
carbon concentrate sample (mass fraction, %)

| Element | Unit | Value |
|---|---|---|
| SiO₂ | % | 41.8 |
| Al₂O₃ | % | 14 |
| MgO | % | 5.07 |
| CaO | % | 7.08 |
| Cu | % | 0.16 |
| Fe | % | 16.2 |
| S | % | 7 |
| Ag | mg/kg | 2.9 |
| Au | mg/kg | 4.71 |
| C graphite | % | 17.7 |
| As | mg/kg | 9190 |
| Ash | % | 67.4 |

The mineralogical composition of the gold-arsenic-bearing carbon concentrate samples was also determined, and the main sulfide minerals identified were pyrite, arsenopyrite and pyrrhotite.

A near-ambient alkaline oxidative (NAAO) leach was performed for 48 hours at different temperatures and NaOH concentrations in an oxidative medium supplied by an oxygen flow. The solid percentage in the NAAO was determined to be up to about 60 wt. %. However, optimal results were obtained at a lower solid percentage of about 25 wt. %. A solid percentage of about 25 wt. % was implemented for the results presented in Table 2 below.

Results were also obtained by a direct cyanidation and a CIL process for comparative purposes. They respectively showed no and substantially low gold recovery, and this even in presence of considerably elevated amounts of activated carbon in the CIL process.

The results obtained with the method as described herein including the NAAO leaching step yield to an arsenic dissolution of up to about 86%, and to a gold dissolution of up to about 50%.

The mechanism by which arsenic dissolves is presented in Equation 2.

6FeAsS+22NaOH+13O₂↔6Fe(OH)₃+2Na₃AsO₃S+4Na₃AsO₄+2Na₂S₂O₃+2H₂O (eq.2)

Equation 2 shows the formation of sodium thiosulfate and sulfides that can react with oxidized gold to form complexes as presented in Equations 4 and 5 below. These gold complexes cannot be preg-robbed and remain soluble and persistent in the leached solution.

Au₊+S²⁻↔AuS⁻ (eq.4)

Au⁺+S₂O₃²⁻↔Au(S₂O₃)₂³⁻ (eq.5)

The gold complexes obtained by the process as described herein were recovered by a solid-liquid separation method. Gold was first converted in gold cyanide by cyanide addition and then recovered on activated carbon. The arsenic was precipitated or crystallized using salts addition with or without temperature adjustment and with or without seeding and was then separated from the liquid stream.

The cyanide containing arsenic-gold-depleted stream was sent to a CIL circuit. The solid residue from the NAAO leaching step was also sent to the CIL circuit with or without conditioning with a surfactant. The CIL was optimized with a sufficient amount of activated carbon to substantially decrease or completely inhibit preg-robbing with a residence time of 48 hours. The use of a surfactant mainly impacted the amount of activated carbon required to achieve optimal gold recovery. Gold recoveries in the range of from about 32% to about 47% were achieved at the gold complexation step (cyanidation step). The effect of the temperature and the NaOH concentration were also evaluated. The maximum arsenic and gold recovery were achieved at a temperature of about 60° C. and a NaOH concentration of about 8% and tantamount to 85.7% and 85.6%, respectively. Finally, the residual cyanidation stream was routed to the detoxification for cyanide destruction and residual arsenic precipitation.

TABLE 2
Results of arsenic and gold recovery by different
methods and at different steps

| | | | Activated | | |
|---|---|---|---|---|---|
| | NaOH | Temperature | carbon | Arsenic | Gold |
| Steps | (wt. %) | (° C.) | (g/L) | (%) | (%) |
| Direct | — | 40 | 0 | 0.2 | 0 |
| cyanidation/ | | 60 | 0 | 0.2 | 0 |
| CIL | — | 40 | 120 | 0 | 17.5 |
| | | 60 | 120 | 0 | 17.6 |
| | — | 40 | 287 | 0 | 22.5 |
| | | 60 | 287 | 0 | 22.3 |
| NAAO | 4 | 40 | — | 8.5 | 20.2 |
| | | 60 | — | 13.3 | 36.7 |
| | 8 | 40 | — | 51.3 | 31.6 |
| | | 60 | — | 85.7 | 49.2 |
| As and Au | 4 | 40 | — | 100.0 | 100.0 |
| removal from | | 60 | — | 100.0 | 100.0 |
| the NAAO | 8 | 40 | — | 99.2 | 100.0 |
| leachate | | 60 | — | 99.2 | 100.0 |
| CIL without | 4 | 40 | 287 | 0.0 | 46.5 |
| surfactant | | 60 | 287 | 0.0 | 32.3 |
| preconditioning | 8 | 40 | 287 | 0.0 | 47.1 |
| | | 60 | 287 | 0.0 | 36.4 |
| CIL with | 4 | 40 | 120 | 0.0 | 46.5 |
| surfactant | | 60 | 120 | 0.0 | 32.3 |
| preconditioning | 8 | 40 | 120 | 0.0 | 47.1 |
| | | 60 | 120 | 0.0 | 36.4 |

As can be seen in Table 2, in cases without surfactants preconditioning the concentration of activated carbon is increased to avoid preg-robbing. In cases with surfactant preconditioning, the concentration of activated carbon can be decreased while maintaining the gold recovery.
(b) Gold Recovery from High-Sulfur and High-Arsenic Carbonaceous Refractory Gold Ores

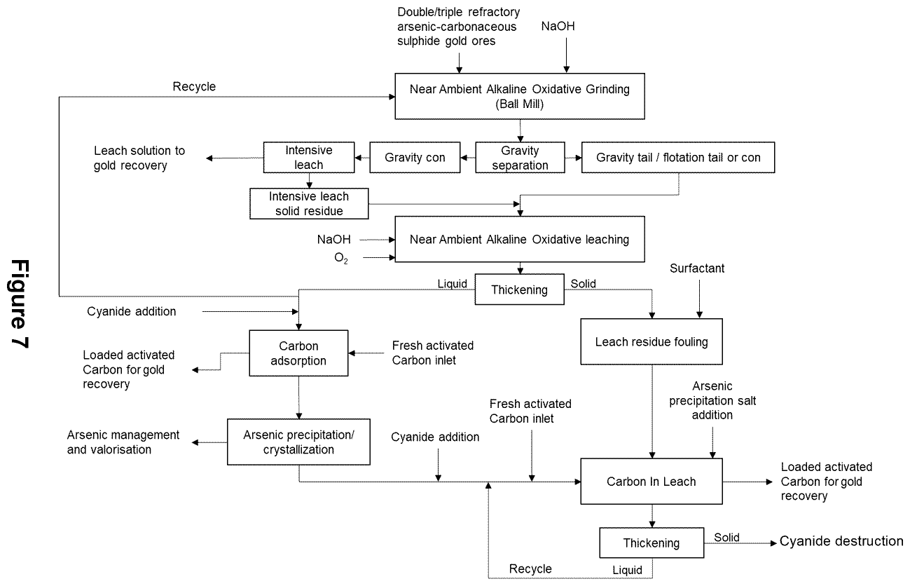

For a more detailed understanding of the disclosure, reference is now made to FIG. 7, which provides a flow diagram of a method for recovering gold from a high-sulfur and high-arsenic carbonaceous refractory gold ore pulp in accordance with a possible embodiment.

As illustrated in FIG. 7, a multistep leaching process was performed on refractory arsenic-carbonaceous sulfide gold ore samples to release and extract gold entwisted in arsenic-bearing sulfide minerals. The chemical composition of the refractory arsenic-carbonaceous sulfide gold ore samples is presented in Table 3.

TABLE 3
Chemical composition of the refractory arsenic-carbonaceous
sulfide gold ore samples (mass fraction, %)

| Element | Unit | Value |
|---|---|---|
| Au | ppm | 23.22 |
| Ag | ppm | 3 |
| Fe | % | 6.20 |
| S | % | 1.51 |
| As | % | 0.62 |
| Sb | ppm | 8100 |
| C | % | 0.34 |

The mineralogical composition of the refractory arsenic-carbonaceous sulfide gold ore samples was also determined, and the main sulfide minerals identified were pyrite, pyrrhotite, arsenopyrite, stibnite, and chalcopyrite.

The NAAO leach was initiated during a grinding step by adding 1 wt. % of NaOH in a ball mill set at a pH=10.5, and at a solid percentage of 60 wt. %. The heat generated during the grinding step improved substantially the dissolution of both arsenic and gold. The absence of cyanide during the grinding step is essential to avoid preg-robbing. The NAAO leaching of the ground material was continued in a pre-cyanidation tank for about 24 hours where an additional 1 wt. % of NaOH was introduced. The leachate thus obtained was then separated from the solid residue prior to a cyanidation step. The leachate was separated from the solid residue by a solid-liquid separation method.

Gold was first converted in gold cyanide by cyanide addition, and then recovered on activated carbon. The arsenic was precipitated or crystallized using salts addition with or without temperature adjustment and with or without seeding, and then separated from the liquid stream.

The cyanide containing arsenic-gold-depleted stream was sent to a CIL circuit. The solid residue from the NAAO leaching step was also sent to the CIL with or without conditioning with a surfactant. The CIL was optimized with a sufficient amount of activated carbon to substantially decrease or completely inhibit preg-robbing with a residence time of either 24 hours or 48 hours. The use of a surfactant mainly impacted the amount of activated carbon required to achieve optimal gold recovery. The maximum arsenic and gold recovery were 50.5% and 94.6%, respectively. Finally, the residual cyanidation stream was routed to the detoxification for cyanide destruction and residual arsenic precipitation. The results are presented in Table 4.

TABLE 4
Results of arsenic and gold recovery by
different methods and at different steps

| | | | Activated | | |
|---|---|---|---|---|---|
| | NaOH | Temperature | carbon | Arsenic | Gold |
| Steps | (%) | (° C.) | (g/L) | (%) | (%) |
| Direct | — | Ambient | 0 | 20.9 | 43.8 |
| cyanidation | | | | | |
| NAAO | 1 and 1 | Grinding | — | 50.5 | 15.4 |
| (Grinding and | | temperature | | | |
| leaching) | | and ambient | | | |
| As and Au | — | Ambient | — | 94.6 | 100.0 |
| removal from | | | | | |
| NAAO | | | | | |
| leachate | | | | | |
| CIL without | — | Ambient | — | 0.0 | 72.0 |
| surfactant | | | | | |
| preconditioning | | | | | |
| CIL without | — | Ambient | 30 | 0.0 | 79.2 |
| surfactant | | | | | |
| preconditioning | | | | | |

### Example 2: Optimization and Validation Tests Under Laboratory Conditions

Optimization and validation tests were performed in order to maximize the economic profit obtained from the gold recovery processes described herein.

(a) Optimization of the Kinetics of Sulfur Oxidation and Arsenic Dissolution Under Controlled Laboratory Conditions

The effect of the temperature and the NaOH concentration on the kinetics of formation of thiosulfate and arsenic dissolution during the first six hours (i.e., initial kinetics) of the NAAO leaching step was determined. The progress of the system's physicochemical parameters was also monitored. The test was carried out on a carbon flotation concentrate sample comprising gold embedded in an arsenopyrite matrix. The elemental composition of the sample is summarized in Table 5.

TABLE 5
Chemical composition of the gold-arsenic-
bearing refractory carbon concentrate

| | Sₜₒₜₐₗ | Cₜₒₜₐₗ | Au | Ag | As |
|---|---|---|---|---|---|
| | (%) | (%) | (mg/kg) | (mg/kg) | (mg/kg) |
| Gold-arsenic-bearing | 6.32 | 23.3 | 4.13 | 1.95 | 8570 |
| refractory carbon concentrate | | | | | |

A three-level factorial design was employed, with reference to midpoints tested during preliminary work. Temperatures of 40° C., 60° C. and 80° C. as well as NaOH concentrations of 6 wt. %, 8 wt. % and 10 wt. % with respect to the ore were tested.

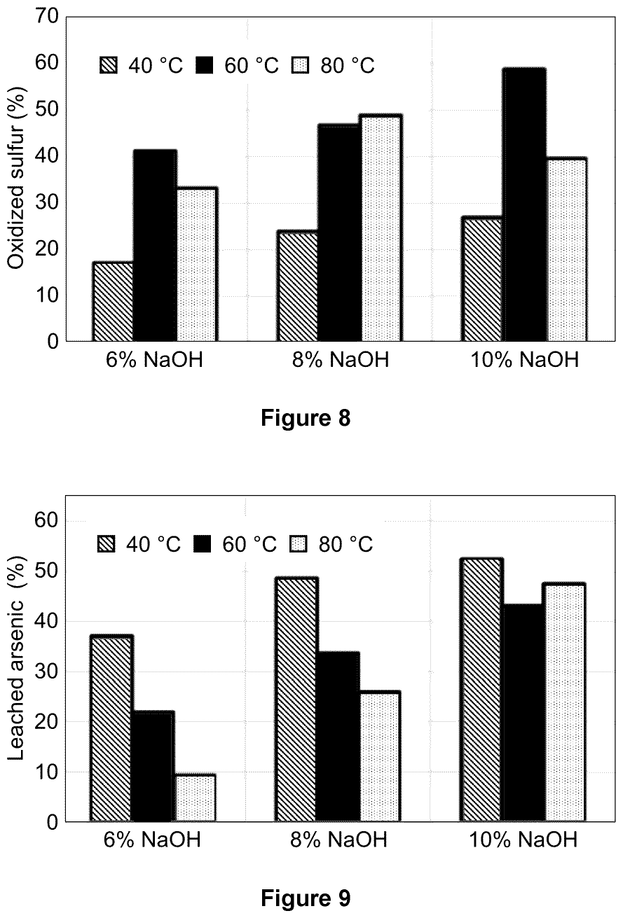

FIGS. 8 and 9 show a grouped bar chart presenting respectively the quantification of oxidized sulfur (%) and leached arsenic (%) as a function of the three different temperatures as well as the three NaOH concentrations. The quantification of oxidized sulfur and leached arsenic was carried out at a constant oxygen flow of about 2 L/min (120 L/h/kg) after about 6 hours of NAAO leaching.

For a constant oxygen flow, an increase in pre-treatment temperature or an increase of the NaOH concentration resulted in an increase in the formation of thiosulfate. This can be attributed to an increase kinetics of sulfur oxidation in these conditions. As can be seen on FIG. 8, the quantity of thiosulfate increases with the pre-treatment temperature up to an inflexion point at which the formation of thiosulfate starts to decline.

As can be seen on FIG. 9, increasing the concentration of NaOH resulted in a substantially greater arsenic dissolution. However, unlike the formation of thiosulfate, dissolved arsenic decreases with increasing pre-treatment temperature. This can be attributed to an improved oxygen solubility at lower temperatures.

(b) Metallurgical Performances

The metallurgical performances were evaluated for a carbon flotation concentrate sample (1 kg). The elemental composition of the sample is presented in Table 6.

TABLE 6
Chemical composition of the gold-arsenic-
bearing refractory carbon concentrate

| | Sₜₒₜₐₗ | Cₜₒₜₐₗ | Au | Ag | As |
|---|---|---|---|---|---|
| | (%) | (%) | (mg/kg) | (mg/kg) | (mg/kg) |
| Gold-arsenic-bearing | 4.97 | 15.3 | 4.88 | 0.9 | 8210 |
| refractory carbon concentrate | | | | | |

The NAAO leaching step was carried out for about 48 hours followed by a cyanidation step also carried out for about 48 hours. The tests were performed under controlled laboratory conditions with different NaOH concentrations varying between about 39 kg/t and about 154 kg/t as well as different oxygen flow rates, varying from 2.1 L/min (126 L/h/kg) to <0.8 L/min (<48 L/h/kg). The temperature was kept constant at about 60° C. from the NAAO leaching step to the cyanidation step. Table 7 summarizes the metallurgical performance obtained for the sample presented in Table 6.

TABLE 7
Metallurgical performance obtained for the gold-arsenic-bearing refractory carbon concentrate

| | NAAO pre-treatment | | | | | | | | Cyanidation | |
|---|---|---|---|---|---|---|---|---|---|---|
| | | | | | | | | Leached | Rejected | recovered |
| | NaOH | NaOH | O₂ | DO (mg/L) | | | Ox. S | gold | Au | Au |
| Test | (kg/t) | stoichiometry | (L/min) | 5 h | 24 h | 48 h | (%) | (mg/L) | (g/t) | (%) |
| #0 | 0 | 0 | 0 | — | — | — | — | — | 2.61 | 46.6 |
| #1 | 39 | 0.21 | 2.1 | 17.9 | 15.8 | 26.5 | 25 | <0.02 | 1.91 | 60.4 |
| #2 | 77 | 0.42 | 2.1 | 17.8 | 21.1 | 27.5 | 48 | 0.35 | 1.32 | 73.3 |
| #3 | 115 | 0.62 | 2.1 | 13.8 | 23.6 | 31.2 | 84 | <0.02 | 1.98 | 80.0 |
| #4 | 154 | 0.83 | 2.1 | 13.3 | 19.4 | 30.5 | 89 | 0.04 | 0.95 | 82.6 |
| #5 | 115 | 0.62 | <0.8 | 4.8 | 13.3 | 13.6 | 61 | 1.04 | 0.96 | 81.4 |
| #6 | 154 | 0.83 | <0.8 | 2.2 | 5.4 | 15.0 | 67 | 0.92 | 1.15 | 78.9 |

* DO: Dissolved Oxygen; Ox. S: Oxidized Sulfur

As can be seen in Table 7, by direct cyanidation of the flotation concentrate (test #0), the gold recovery reached 46.6%. With the addition of an NAAO leaching step, the gold recovery after cyanidation reached up to 82.6%.

Similar to the results obtained over 6 hours, the oxidized sulfur quantified after 48 hours is proportional to the NaOH concentration and thus to the NaOH stoichiometry in the NAAO leaching step. Table 7 also shows a direct correlation between the oxidation of sulfides by NAAO and the gold recovery after cyanidation. A correlation can therefore be established between the NaOH consumption and stoichiometry during the NAAO leaching step and the gold recovery after cyanidation.

The presence of oxygen also plays a role in the oxidation of sulfides. Tests carried out at a lower oxygen flow rate (<0.8 L/min) show that the presence of dissolved oxygen was not only limited to the addition or not of the reagent. Indeed, the dissolved oxygen measured remains above 0 despite the decrease in the oxygen flow rate to values <0.8 L/min. For a constant NaOH concentration, a lower oxygen flow rate leads to a substantial decrease in the oxidation of sulfides (about 20%), and this, without significantly affecting the gold recovery. This can be explained by the presence of the oxidation of sulfur limiting value required to allow an optimal accessibility to gold surfaces for cyanidation, ensuring that a gold recovery ceiling is reached. Despite a decrease in the oxygen flow rate, the oxidation of sulfides was still sufficient after 48 hours to allow an average gold recovery of about 80%.

The differences in the kinetics of formation of thiosulfate and of dissolved gold in the NAAO leaching step as a function of the oxygen flow rate were also evaluated. The nature of the by-products resulting from the oxidation of sulfides during the NAAO leaching step is significantly influenced by the oxygen flow rate. Indeed, for a constant NaOH concentration, the distribution of thiosulfate formed during the NAAO leaching step increases by about 30% with a lower oxygen flow rate. However, the formation of thiosulfate eventually decreases to zero after 48 hours of NAAO leaching step. This greater formation of thiosulfate with a lower oxygen flow rate is consistent with oxidation conditions less conducive to the total and rapid oxidation of sulfides to sulfates. Even if thiosulfates were measured after 6 hours of NAAO leaching with an oxygen flow rate of about 2.1 L/min, maintaining this flow rate for 48 hours makes it possible to rapidly complete the oxidation of residual thiosulfates, the completion the oxidation of thiosulfates to sulfates, although slower, is also fully completed after 48 hours with a lower oxygen flow rate. Thiosulfates can therefore be considered as a reaction intermediate in the NAAO leaching process.

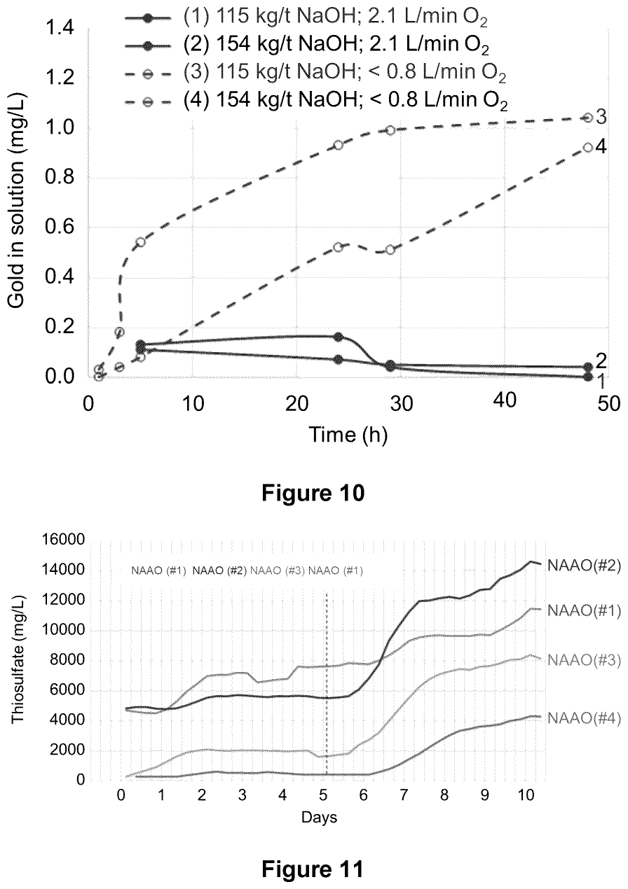

The gold dissolution during the NAAO leaching step is also favored with a lower oxygen flow rate. FIG. 10 presents a graph of the gold in solution (mg/L) as a function of time (hours). As can be seen in FIG. 10, with an oxygen flow rate of about 2.1 L/min (red line (1); and black line (2)), the gold contents in solution varies between 0 and 0.2 mg/L. An oxygen flow rate value <0.8 L/min favors a gradual gold dissolution, until reaching between 0.9 and 1.05 mg/L after 48 hours (red line (3); and black line (4)). The decrease in oxygen flow rate also plays a role in the kinetics of NaOH consumption. This is consistent with the lower percentages of oxidized sulfur measured after the NAAO leaching step with a lower oxygen flow rate (<0.8 L/min), despite an identical NaOH concentration. This suggests that the oxidation of sulfides reaction in the NAAO leaching step is governed by a second-order reaction in which the NaOH concentrations and dissolved oxygen have a direct impact on the sulfide oxidation rate. The mass transfer leading to the dissolution of oxygen in solution is a major component of the efficiency of the NAAO leaching process.

### Example 3: Pilot Test

(a) Pilot-Scale NAAO Leaching Circuit

The NAAO pre-treatment pilot tests were carried out in a circuit consisting of four tanks in a series, each tank having a volume between 40 and 45 L. The pulp, process water and NaOH were fed into the first tank by peristaltic pumps, the transfer to the second to the fourth tanks was performed by overflow. The feed rate of the pilot unit was 1 kg/h for the ore or 2.33 kg/h for the pulp, considering a pulp comprising 25 wt. % of solids. The calculated residence time was 12 hours per tank, for a total of 48 hours over the entire circuit.

After the fourth tank, the pulp was filtered through a filter pan to collect solids and filtrates for analysis, or later use if necessary, to recirculate any potentially residual NaOH. Each reactor was supplied with oxygen using a mass flow controller to allow a constant oxygen supply over time. The tanks were covered with an external insulation and their contents were kept at a temperature of 60° C. using a steam heating element. Each tank was also equipped with a motor with a stirring rod to promote the dispersion of oxygen in order to promote mass transfer.

The cyanidation process was carried out in close reactors on samples taken every 12 hours at the discharge of the fourth tank and before filtration.

Prior to the addition of cyanide, the samples taken at the discharge of the fourth tank were conditioned with a surfactant (Dehscofix™ DG 30) without oxygen for 30 minutes to prevent preg-robbing by carbonaceous material. The conditioning and cyanidation steps were carried out at 60° C. The reactors were also fitted with a gas condenser to limit the loss of water vapor and maintain a constant percentage of solids throughout the tests.

(b) Pilot Test Operating Conditions

The operating conditions tested during the pilot testing of the NAAO leaching process and the cyanidation step are summarized in Tables 8 and 9, respectively.

The objective of each operating condition of the NAAO leaching process was:
conditions 1: Maximize sulfur oxidation during the NAAO leaching step to allow maximum gold recovery during subsequent cyanidation; and
conditions 2: Limit the operational costs of the process related to the consumption of reagents (e.g., NaOH and oxygen).

Feed and discharge samples from all tanks from the NAAO circuit were taken every 12 hours to assess the metallurgical performances of the process and to validate the solid percentages. The physicochemical parameters were monitored every 6 hours in each of the four tanks of the circuit.

TABLE 8
Operating conditions of the NAAO leaching process

| NAAO leaching process | conditions 1 | conditions 2 |
|---|---|---|
| NaOH (kg/t) | 160 | 90 |
| O₂ Flow rate-First tank (L/min) | 2.1 | 1 |
| O₂ Flow rate-Second tank (L/min) | 2.1 | 1 |
| O₂ Flow rate-Third tank (L/min) | 2.1 | 1 |
| O₂ Flow rate-Fourth tank (L/min) | 2.1 | 2 |
| Temperature (° C.) | 60 | 60 |
| Solid percentage (%) | 25 | 25 |
| Agitation (rpm) | 250 | 250 |

The cyanide concentration was readjusted frequently after titration to assess the total cyanide consumption. The pH was maintained between 10.5 and 11 using an automatic pH controller allowing the addition of limewater. Samples were taken after 24 and 48 hours to follow the metallurgical performances and the formation of cyanidation by-products (cyanates, sulfates, thiosulfates, and thiocyanates).

TABLE 9
Operating conditions of the cyanidation process
Cyanidation process (48 hours)

| | |
|---|---|
| pH; adjusted with limewater | 10.5-11 |
| NaCN (mg/L) | 500 |
| Activated carbon (g/L) | 300 |
| O₂ Flow rate (L/min) | 2.1 |
| Agitation (rpm) | 250 |
| Temperature (° C.) | 60 |
| Solid percentage (%) | 30 |
| Surfactant (Dehscofix ™ DG 30) (g/t) | 1000 |

(c) Pilot Testing of the Process Under Real-Time Operating Conditions

FIG. 11 presents a graph of concentration of thiosulfates (mg/L) versus time (days) for the first tank (NAAO #1; blue line), the second tank (NAAO #2; red line), the third tank (NAAO #3; grey line), and the fourth tank (NAAO #4; green line). The dotted line in FIG. 11 represents the change from operating conditions 1 to 2, which, as summarized in Table 8, implies a reduction in the NaOH concentration and oxygen flow rate.

As seen in FIG. 11, with operating conditions 1, the thiosulfate concentration profile decreases from the first tank (NAAO #1: 7800 mg/L) to the fourth tank (NAAO #4: <500 mg/L). This profile is consistent with the results obtained under laboratory conditions and corresponds to rapid initial formation of thiosulfates and gradual oxidation as the NAAO leaching progresses. As also seen in FIG. 11, with operating conditions 2, a significant increase in the initial formation of thiosulfates in the first (NAAO #1) and second *NAAO #2 tanks, with a substantially higher thiosulfate concentration in the second tank (NAAO #2: 14000 mg/L). This overproduction of thiosulfates can be attributed to the reduction of the NaOH concentration and oxygen flow rate. The thiosulfate concentration in the third (NAAO #3) and fourth (NAAO #4) tanks is substantially lower due to the oxidation of thiosulfates to sulfates. However, it does not allow a complete elimination of thiosulfates at the discharge of the fourth tank after 48 hours of residence time.

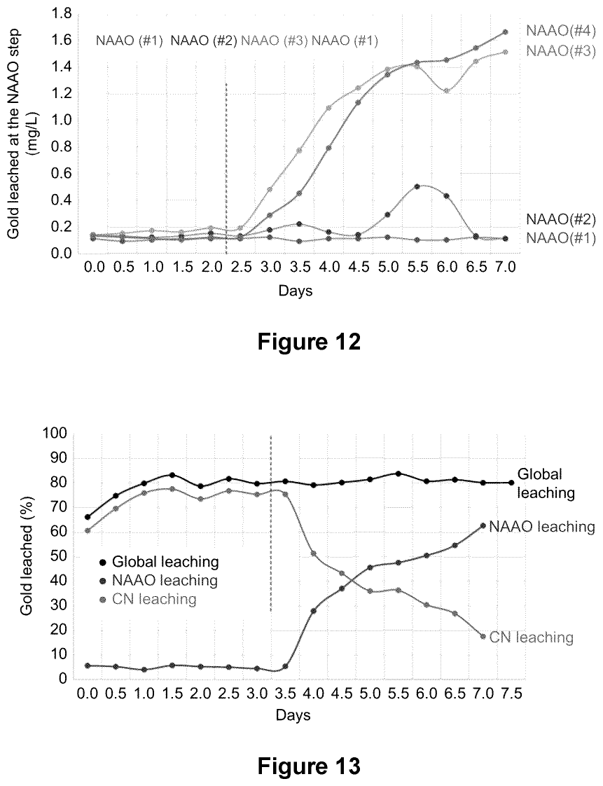

The gold leached during the NAAO leaching step was monitored and measured in all the process tanks and the results are presented in FIG. 12 in which the dotted line represents the switch from operating conditions 1 to 2. Under aggressive NAAO leaching operating conditions (conditions 1), less than 0.2 mg/L gold was leached after a residence time of 48 hours. However, with milder oxidation operating conditions (conditions 2), a gradual increase in the gold leached in the NAAO leaching step can be observed, specifically in the third and fourth tanks. This phenomenon appears to be not only consistent with the results obtained during laboratory scale tests, but also to coincide with a significant formation of thiosulfates in the first and especially second tanks following the passage from operating conditions 1 to 2.

During the pilot-scale test of the NAAO leaching step, cyanidation was initiated every 12 hours on samples from the discharge of the fourth tank to evaluate the metallurgical performances of the process. FIG. 13 is a graph of the results presenting the percentage of gold leached during the cyanide leaching process, the NAAO leaching process, and for the global recovery process. The dotted line represents the switch from operating conditions 1 to 2.

As seen in FIG. 13, once the NAAO circuit has been stabilized with operating conditions 1, cyanidations carried out for 48 hours showed an 80% gold recovery. These performances are consistent with the results obtained during laboratory scale tests. In the pilot-scale test, the oxidation of the sulfur matrix of about 95% led to an overall estimated gold recovery of about 80%. This overall gold recovery can be broken down into 5% resulting from the NAAO leaching process and 75% gold recovery following the cyanidation process of the samples subjected to the oxidation of the sulfides by the NAAO leaching step.

As also seen in FIG. 13, after decreasing the concentration of reagents (conditions 2), no significant change in terms of the overall gold recovery was measured. The distribution of gold leached during the NAAO and cyanidation leaching steps is reversed for the two operating conditions (conditions 1 and 2). The gold leaching in the alkaline sulfide oxidation process becomes preponderant over the gold leaching in cyanidation.

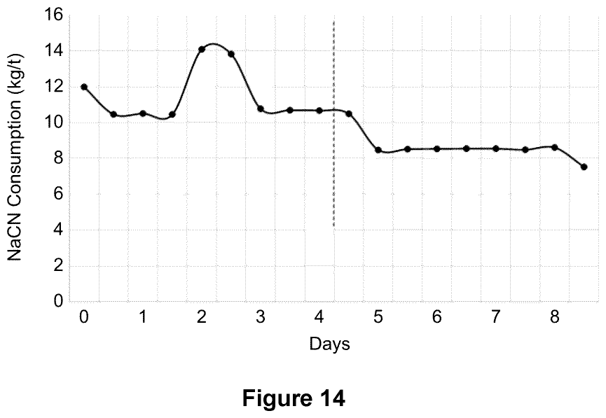

FIG. 14 is a graph of the NaCN consumption as a function of time, the dotted line represents a change in operating conditions. As seen in FIG. 14, a significant decrease in the NaCN consumption (in the order of 2 kg/t) was measured during cyanidations carried out on samples resulting from the NAAO leaching pre-treatment under operating conditions 2 compared to the operating conditions 1.

1. A method for recovering gold from a refractory gold ore, the method comprising the steps of:
leaching the refractory gold ore with an alkaline reagent under atmospheric pressure, at a temperature below the boiling point, and in the presence of an oxidant to obtain a refractory gold ore mixture including a gold-containing leachate and a gold-unlocked solid residue;
separating the gold-containing leachate from the gold-unlocked solid residue;
mixing at least the gold-unlocked solid residue with a gold complexing agent to form a soluble gold-containing complex; and
recovering gold from the gold-containing complex.

2. The method of claim 1, further comprising mixing at least the gold-containing leachate with the gold complexing agent.

3. The method of claim 1 or 2, wherein the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

4. The method of claim 3, wherein the refractory gold ore includes pyrite, arsenopyrite and pyrrhotite.

5. The method of claim 3, wherein the refractory gold ore includes pyrite, pyrrhotite, arsenopyrite, stibnite, and chalcopyrite.

6. The method of any one of claims 1 to 5, wherein the alkaline reagent is selected from the group consisting of calcium carbonate, sodium carbonate, calcium hydroxide, sodium hydroxide, and a mixture of at least two thereof.

7. The method of claim 6, wherein the alkaline reagent is sodium hydroxide.

8. The method of any one of claims 1 to 7, wherein the oxidant is selected from the group consisting of air, oxygen, ozone, peroxide, iron oxide, perchlorates, and a mixture of at least two thereof.

9. The method of claim 8, wherein the oxidant is oxygen.

10. The method of any one of claims 1 to 9, wherein the leaching step is carried out at ambient temperature.

11. The method of any one of claims 1 to 9, wherein the leaching step is carried out at a temperature in the range of from about 10° C. to about 100° C., or from about 10° C. to about 95° C., or from 10° C. to about 90° C., or from about 10° C. to about 85° C., or from about 10° C. to about 80° C., or from about 10° C. to about 70° C., or from about 10° C. to about 60° C., or from about 40° C. to about 100° C., or from about 40° C. to about 95° C., or from about 40° C. to about 90° C., or from about 40° C. to about 85° C., or from about 40° C. to about 80° C., or from about 40° C. to about 70° C., or from about 40° C. to about 60° C.

12. The method of any one of claims 1 to 11, wherein the leaching step is carried out for a time period in the range of from about 8 hours to about 96 hours.

13. The method of any one of claims 1 to 12, wherein the refractory gold ore mixture comprises from about 0.5 wt. % to about 30 wt. % of the alkaline reagent.

14. The method of any one of claims 1 to 13, wherein the refractory gold ore mixture has a pH in the range of from about 8 to about 14.

15. The method of any one of claims 1 to 14, wherein refractory gold ore mixture has a solid content in the range of from about 25 wt. % to about 60 wt. %.

16. The method of any one of claims 1 to 15, wherein the gold-containing leachate comprises arsenic.

17. The method of any one of claims 1 to 16, wherein the gold-unlocked solid residue has a percentage of solid in the range of from about 35 wt. % to about 85 wt. %, or from about 40 wt. % to about 85 wt. %, or from 50 wt. % to about 85 wt. %, or from about 60 wt. % to about 85 wt. %, or from about 70 wt. % to about 85 wt. %.

18. The method of any one of claims 1 to 17, wherein separating the gold-containing leachate from the gold-unlocked solid residue is performed by thickening or filtration.

19. The method of any one of claims 1 to 18, wherein the gold complexing agent is selected from the group consisting of cyanide salts, thiocyanate salts, thiourea salts, thiocyanate salts, ammonium salts, halide salts, and a combination of at least two thereof.

20. The method of claim 19, wherein the gold complexing agent is a cyanide salt selected from the group consisting of sodium cyanide, potassium cyanide, and calcium cyanide.

21. The method of claim 20, wherein the cyanide salt is sodium cyanide.

22. The method of any one of claims 1 to 21, wherein the mixing step is carried out for a period of time in the range of from about 8 hours to about 96 hours.

23. The method of any one of claims 1 to 22, further comprising recovering the gold-containing complex by adsorption on an absorbent.

24. The method of claim 23, wherein the absorbent is activated carbon or resin beads.

25. The method of claim 23 or 24, further comprising desorbing gold from the absorbent.

26. The method of any one of claims 1 to 25, further comprising comminuting the refractory gold ore to obtain refractory gold ore particles having a predetermined size.

27. The method of claim 26, wherein the comminuting step is performed by ball milling or stirred milling.

28. The method of claim 26 or 27, wherein the refractory gold ore particles have a diameter in the range of from about 1 μm to about 300 μm, or from about 1 μm to about 100 μm, or from about 1 μm to about 75 μm, or from about 1 μm to about 60 μm, or from about 1 μm to about 50 μm, or from about 1 μm to about 40 μm, or from about 1 μm to about 30 μm, or from about 1 μm to about 25 μm.

29. The method of any one of claims 26 to 28, wherein the comminuting step is performed prior to the leaching step.

30. The method of any one of claims 26 to 28, wherein the leaching and comminuting steps are performed simultaneously.

31. The method of any one of claims 1 to 30, further comprising adding water to the refractory gold ore to obtain a refractory gold ore pulp or slurry.

32. The method of any one of claims 1 to 31, further comprising adding water to the gold-unlocked solid residue to obtain a gold-unlocked solid residue pulp or slurry.

33. The method of any one of claims 1 to 32, further comprising adding a surfactant to the gold-unlocked solid residue prior to the mixing step.

34. The method of any one of claims 1 to 33, further comprising recycling at least a portion of the alkaline reagent.

35. The method of any one of claims 1 to 34, further comprising recycling at least a portion of the gold complexing agent.

36. A method for recovering gold from a refractory gold ore being subject to sulfide locking, the method comprising the steps of:
leaching the refractory gold ore with an alkaline reagent under atmospheric pressure, at a temperature above 40° C. and in the presence of an oxidant to produce at least one metal thiosulfate and obtain a refractory gold ore mixture including a gold-containing leachate and a gold-unlocked solid residue;
mixing at least the gold-unlocked solid residue with a gold complexing agent to form a soluble gold-containing complex; and
recovering gold from the gold-containing complex.

37. The method of claim 36, further comprising separating the gold-containing leachate from the gold-unlocked solid residue.

38. The method of claim 36 or 37, further comprising mixing at least the gold-containing leachate with the gold complexing agent.

39. The method of any one of claims 36 to 38, wherein the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

40. The method of claim 39, wherein the refractory gold ore includes pyrite, arsenopyrite and pyrrhotite.

41. The method of claim 39, wherein the refractory gold ore includes pyrite, pyrrhotite, arsenopyrite, stibnite, and chalcopyrite.

42. The method of any one of claims 36 to 41, wherein the alkaline reagent is selected from the group consisting of calcium carbonate, sodium carbonate, calcium hydroxide, sodium hydroxide, and a mixture of at least two thereof.

43. The method of claim 42, wherein the alkaline reagent is sodium hydroxide.

44. The method of claim 43, wherein the sodium hydroxide is added in an amount up to about 4 equivalents per equivalent of sulfur contained in the refractory gold ore.

45. The method of claim 44, wherein the sodium hydroxide is added in an amount of about 2 equivalents per equivalent of sulfur contained in the refractory gold ore.

46. The method of any one of claims 36 to 45, wherein the oxidant is selected from the group consisting of air, oxygen, ozone, peroxide, iron oxide, perchlorates, and a mixture of at least two thereof.

47. The method of claim 46, wherein the oxidant is oxygen.

48. The method of any one of claims 36 to 47, wherein the oxidant is added at a flow rate inferior to about 144 L/h/kg, or inferior to about 132 L/h/kg, or inferior to about 120 L/h/kg, or inferior to about 108 L/h/kg, or inferior to about 96 L/h/kg, or inferior to about 84 L/h/kg, or inferior to about 72 L/h/kg, or inferior to about 60 L/h/kg, or inferior to about 48 L/h/kg.

49. The method of claim 48, wherein the oxidant is added at a flow rate inferior to about 48 L/h/kg.

50. The method of any one of claims 36 to 49, wherein the leaching step is carried out at a temperature below the boiling point of the refractory gold ore mixture.

51. The method of any one of claims 36 to 49, wherein the leaching step is carried out at a temperature in the range of from 40° C. to 100° C., or from 40° C. to 90° C., or from 40° C. to 80° C., or from 40° C. to 70° C.

52. The method of any one of claims 36 to 51, wherein the leaching step is carried out for a time period in the range of from about 8 hours to about 96 hours.

53. The method of any one of claims 36 to 52, wherein the refractory gold ore mixture has a pH in the range of from about 8 to about 14.

54. The method of any one of claims 36 to 53, wherein the refractory gold ore mixture has a solid content in the range of from about 25 wt. % to about 60 wt. %.

55. The method of any one of claims 36 to 54, wherein the gold-containing leachate comprises arsenic.

56. The method of any one of claims 36 to 55, wherein the gold-unlocked solid residue has a percentage of solid in the range of from about 35 wt. % to about 85 wt. %, or from about 40 wt. % to about 85 wt. %, or from 50 wt. % to about 85 wt. %, or from about 60 wt. % to about 85 wt. %, or from about 70 wt. % to about 85 wt. %.

57. The method of any one of claims 36 to 56, further comprising adding a surfactant to refractory gold ore mixture or to the gold-unlocked solid residue prior to the mixing step.

58. The method of any one of claims 37 to 57, wherein separating the gold-containing leachate from the gold-unlocked solid residue is performed by a solid-liquid separation process.

59. The method of any one of claims 36 to 58, wherein the gold complexing agent is selected from the group consisting of cyanide salts, thiocyanate salts, thiourea salts, thiocyanate salts, ammonium salts, halide salts, and a combination of at least two thereof.

60. The method of claim 59, wherein the gold complexing agent is a cyanide salt selected from the group consisting of sodium cyanide, potassium cyanide, and calcium cyanide.

61. The method of claim 60, wherein the cyanide salt is sodium cyanide.

62. The method of any one of claims 36 to 61, wherein the mixing step is carried out for a period of time in the range of from about 8 hours to about 96 hours.

63. The method of any one of claims 36 to 62, further comprising recovering the gold-containing complex by adsorption on an absorbent.

64. The method of claim 63, wherein the absorbent is activated carbon or resin beads.

65. The method of claim 63 or 64, further comprising desorbing gold from the absorbent.

66. The method of any one of claims 36 to 65, further comprising comminuting the refractory gold ore to obtain refractory gold ore particles having a predetermined size.

67. The method of claim 66, wherein the comminuting step is performed by ball milling or stirred milling.

68. The method of claim 66 or 67, wherein the refractory gold ore particles have a diameter in the range of from about 1 μm to about 300 μm, or from about 1 μm to about 100 μm, or from about 1 μm to about 75 μm, or from about 1 μm to about 60 μm, or from about 1 μm to about 50 μm, or from about 1 μm to about 40 μm, or from about 1 μm to about 30 μm, or from about 1 μm to about 25 μm.

69. The method of any one of claims 66 to 68, wherein the comminuting step is performed prior to the leaching step.

70. The method of any one of claims 66 to 68, wherein the leaching and comminuting steps are performed simultaneously.

71. The method of any one of claims 36 to 70, further comprising adding water to the refractory gold ore to obtain a refractory gold ore pulp or slurry prior to the leaching step.

72. The method of any one of claims 36 to 71, further comprising adding water to the gold-unlocked solid residue to obtain a gold-unlocked solid residue pulp or slurry prior to the mixing step.

73. The method of any one of claims 36 to 72, further comprising recycling at least a portion of the alkaline reagent.

74. The method of any one of claims 36 to 73, further comprising recycling at least a portion of the gold complexing agent.

75. A method for recovering gold from a refractory gold ore, the method comprising the steps of:
concentrating the refractory gold ore to obtain a refractory gold ore concentrate comprising at least 0.1 wt. % of organic carbon or arsenic;
leaching the refractory gold ore concentrate with an alkaline reagent under atmospheric pressure, at a temperature below the boiling point, and in the presence of an oxidant to obtain a refractory gold ore concentrate mixture including a gold-containing leachate and a gold-unlocked solid residue;
mixing at least the gold-unlocked solid residue with a gold complexing agent to form a soluble gold-containing complex; and
recovering gold from the gold-containing complex.

76. The method of claim 75, further comprising separating the gold-containing leachate from the gold-unlocked solid residue.

77. The method of claim 75 or 76, further comprising mixing at least the gold-containing leachate with the cyanide complexing agent.

78. The method of any one of claims 75 to 77, wherein the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

79. The method of claim 78, wherein the refractory gold ore includes pyrite, arsenopyrite and pyrrhotite.

80. The method of claim 78, wherein the refractory gold ore includes pyrite, pyrrhotite, arsenopyrite, stibnite, and chalcopyrite.

81. The method of any one of claims 75 to 80, wherein the concentrating step is performed by flotation.

82. The method of any one of claims 75 to 81, wherein the refractory gold ore concentrate comprises at least 1 wt. %, or at least 2 wt. %, or at least 3 wt. %, or at least 4 wt. %, or at least 5 wt. % of organic carbon or arsenic.

83. The method of claim 82, wherein the refractory gold ore concentrate comprises at least 5 wt. % of organic carbon or arsenic.

84. The method of any one of claims 75 to 83, wherein the alkaline reagent is selected from the group consisting of calcium carbonate, sodium carbonate, calcium hydroxide, sodium hydroxide, and a mixture of at least two thereof.

85. The method of claim 84, wherein the alkaline reagent is sodium hydroxide.

86. The method of claim 85, wherein the refractory gold ore comprise sulfide and the sodium hydroxide is added in an amount up to about 4 equivalents per equivalent of sulfur contained in the refractory gold ore.

87. The method of claim 86, wherein the sodium hydroxide is added in an amount of about 2 equivalents per equivalent of sulfur contained in the refractory gold ore.

88. The method of any one of claims 75 to 87, wherein the oxidant is selected from the group consisting of air, oxygen, ozone, peroxide, iron oxide, perchlorates, and a mixture of at least two thereof.

89. The method of claim 88, wherein the oxidant is oxygen.

90. The method of any one of claims 75 to 89, wherein the oxidant is added at a flow rate inferior to about 144 L/h/kg, or inferior to about 132 L/h/kg, or inferior to about 120 L/h/kg, or inferior to about 108 L/h/kg, or inferior to about 96 L/h/kg, or inferior to about 84 L/h/kg, or inferior to about 72 L/h/kg, or inferior to about 60 L/h/kg, or inferior to about 48 L/h/kg.

91. The method of claim 90, wherein the oxidant is added at a flow rate inferior to about 48 L/h/kg.

92. The method of any one of claims 75 to 91, wherein the leaching step is carried out at ambient temperature.

93. The method of any one of claims 75 to 91, wherein the leaching step is carried out at a temperature in the range of from 10° C. to 100° C., or from 10° C. to 90° C., or from 10° C. to 80° C., or from 10° C. to 70° C., or from 40° C. to 100° C., or from 40° C. to 90° C., or from 40° C. to 80° C., or from 40° C. to 70° C.

94. The method of any one of claims 75 to 93, wherein the leaching step is carried out for a time period in the range of from about 8 hours to about 96 hours.

95. The method of any one of claims 75 to 94, wherein the refractory gold ore concentrate mixture has a pH in the range of from about 8 to about 14.

96. The method of any one of claims 75 to 95, wherein the refractory gold ore concentrate mixture has a solid content in the range of from about 25 wt. % to about 60 wt. %.

97. The method of any one of claims 75 to 96, wherein the gold-containing leachate comprises arsenic.

98. The method of any one of claims 75 to 97, wherein the gold-unlocked solid residue has a percentage of solid in the range of from about 35 wt. % to about 85 wt. %, or from about 40 wt. % to about 85 wt. %, or from 50 wt. % to about 85 wt. %, or from about 60 wt. % to about 85 wt. %, or from about 70 wt. % to about 85 wt. %.

99. The method of any one of claims 75 to 98, further comprising adding a surfactant to refractory gold ore concentrate mixture or to the gold-unlocked solid residue prior to the mixing step.

100. The method of any one of claims 76 to 99, wherein separating the gold-containing leachate from the gold-unlocked solid residue is performed by a solid-liquid separation process.

101. The method of any one of claims 75 to 100, wherein the gold complexing agent is selected from the group consisting of cyanide salts, thiocyanate salts, thiourea salts, thiocyanate salts, ammonium salts, halide salts, and a combination of at least two thereof.

102. The method of claim 101, wherein the gold complexing agent is a cyanide salt selected from the group consisting of sodium cyanide, potassium cyanide, and calcium cyanide.

103. The method of claim 102, wherein the cyanide salt is sodium cyanide.

104. The method of any one of claims 75 to 103, wherein the mixing step is carried out for a period of time in the range of from about 8 hours to about 96 hours.

105. The method of any one of claims 75 to 104, further comprising recovering the gold-containing complex by adsorption on an absorbent.

106. The method of claim 105, wherein the absorbent is activated carbon or resin beads.

107. The method of claim 105 or 106, further comprising desorbing gold from the absorbent.

108. The method of any one of claims 75 to 107, further comprising comminuting the refractory gold ore to obtain refractory gold ore particles having a predetermined size.

109. The method of any one of claims 75 to 108, further comprising comminuting the refractory gold ore concentrate to obtain refractory gold ore concentrate particles having a predetermined size.

110. The method of claim 109, wherein the comminuting step is performed by ball milling or stirred milling.

111. The method of claim 109 or 110, wherein the refractory gold ore concentrate particles have a diameter in the range of from about 1 μm to about 300 μm, or from about 1 μm to about 100 μm, or from about 1 μm to about 75 μm, or from about 1 μm to about 60 μm, or from about 1 μm to about 50 μm, or from about 1 μm to about 40 μm, or from about 1 μm to about 30 μm, or from about 1 μm to about 25 μm.

112. The method of any one of claims 109 to 111, wherein the comminuting step is performed prior to the leaching step.

113. The method of any one of claims 109 to 111, wherein the leaching and comminuting steps are performed simultaneously.

114. The method of any one of claims 75 to 113, further comprising adding water to the refractory gold ore concentrate to obtain a refractory gold ore concentrate pulp or slurry prior to the leaching step.

115. The method of any one of claims 75 to 114, further comprising adding water to the gold-unlocked solid residue to obtain a gold-unlocked solid residue pulp or slurry prior to the mixing step.

116. The method of any one of claims 75 to 115, further comprising recycling at least a portion of the alkaline reagent.

117. The method of any one of claims 75 to 116, further comprising recycling at least a portion of the gold complexing agent.

118. A method for recovering gold from a refractory gold ore, the method comprising the steps of:
comminuting the refractory gold ore in the presence of an alkaline reagent and an oxidant under atmospheric pressure to obtain refractory gold ore particles;
concentrating the oxidized refractory gold ore particles to obtain refractory gold ore concentrate particles;
leaching the refractory gold ore concentrate particles with the alkaline reagent under atmospheric pressure, at a temperature below the boiling point, and in the presence of the oxidant to obtain a refractory gold ore concentrate mixture including a gold-containing leachate and a gold-unlocked solid residue;
mixing at least the gold-unlocked solid residue with a gold complexing agent to form a soluble gold-containing complex; and
recovering gold from the gold-containing complex.

119. The method of claim 118, further comprising separating the gold-containing leachate from the gold-unlocked solid residue.

120. The method of claim 118 or 119, further comprising mixing at least the gold-containing leachate with the gold complexing agent.

121. The method of any one of claims 118 to 120, wherein the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

122. The method of claim 121, wherein the refractory gold ore includes pyrite, arsenopyrite and pyrrhotite.

123. The method of claim 121, wherein the refractory gold ore includes pyrite, pyrrhotite, arsenopyrite, stibnite, and chalcopyrite.

124. The method of any one of claims 118 to 123, wherein the concentrating step is performed by flotation.

125. The method of any one of claims 118 to 123, wherein the concentrating step is performed by gravity concentration.

126. The method of any one of claims 118 to 125, wherein the refractory gold ore concentrate particles comprise at least 0.1 wt. % of organic carbon or arsenic.

127. The method of any one of claims 118 to 126, wherein the alkaline reagent is selected from the group consisting of calcium carbonate, sodium carbonate, calcium hydroxide, sodium hydroxide, and a mixture of at least two thereof.

128. The method of claim 127, wherein the alkaline reagent is sodium hydroxide.

129. The method of claim 128, wherein the refractory gold ore comprise sulfide and the sodium hydroxide is added in an amount up to about 4 equivalents per equivalent of sulfur contained in the refractory gold ore.

130. The method of claim 129, wherein the sodium hydroxide is added in an amount of about 2 equivalents per equivalent of sulfur contained in the refractory gold ore.

131. The method of any one of claims 118 to 130, wherein the oxidant is selected from the group consisting of air, oxygen, ozone, peroxide, iron oxide, perchlorates, and a mixture of at least two thereof.

132. The method of claim 131, wherein the oxidant is oxygen.

133. The method of any one of claims 118 to 132, wherein the oxidant is added at a flow rate inferior to about 144 L/h/kg, or inferior to about 132 L/h/kg, or inferior to about 120 L/h/kg, or inferior to about 108 L/h/kg, or inferior to about 96 L/h/kg, or inferior to about 84 L/h/kg, or inferior to about 72 L/h/kg, or inferior to about 60 L/h/kg, or inferior to about 48 L/h/kg.

134. The method of claim 133, wherein the oxidant is added at a flow rate inferior to about 48 L/h/kg.

135. The method of any one of claims 118 to 134, wherein the leaching step is carried out at ambient temperature.

136. The method of any one of claims 118 to 134, wherein the leaching step is carried out at a temperature in the range of from 10° C. to 100° C., or from 10° C. to 90° C., or from 10° C. to 80° C., or from 10° C. to 70° C., or from 40° C. to 100° C., or from 40° C. to 90° C., or from 40° C. to 80° C., or from 40° C. to 70° C.

137. The method of any one of claims 118 to 136, wherein the leaching step is carried out for a time period in the range of from about 8 hours to about 96 hours.

138. The method of any one of claims 118 to 137, wherein the refractory gold ore concentrate mixture has a pH in the range of from about 8 to about 14.

139. The method of any one of claims 118 to 138, wherein the refractory gold ore concentrate mixture has a solid content in the range of from about 25 wt. % to about 60 wt. %.

140. The method of any one of claims 118 to 139, wherein the gold-containing leachate comprises arsenic.

141. The method of any one of claims 118 to 140, wherein the gold-unlocked solid residue has a percentage of solid in the range of from about 35 wt. % to about 85 wt. %, or from about 40 wt. % to about 85 wt. %, or from 50 wt. % to about 85 wt. %, or from about 60 wt. % to about 85 wt. %, or from about 70 wt. % to about 85 wt. %.

142. The method of any one of claims 118 to 141, further comprising adding a surfactant to refractory gold ore concentrate mixture or to the gold-unlocked solid residue prior to the mixing step.

143. The method of any one of claims 119 to 142, wherein separating the gold-containing leachate from the gold-unlocked solid residue is performed by a solid-liquid separation process.

144. The method of any one of claims 118 to 143, wherein the gold complexing agent is selected from the group consisting of cyanide salts, thiocyanate salts, thiourea salts, thiocyanate salts, ammonium salts, halide salts, and a combination of at least two thereof.

145. The method of claim 144, wherein the gold complexing agent is a cyanide salt selected from the group consisting of sodium cyanide, potassium cyanide, and calcium cyanide.

146. The method of claim 145, wherein the cyanide salt is sodium cyanide.

147. The method of any one of claims 118 to 146, wherein the mixing step is carried out for a period of time in the range of from about 8 hours to about 96 hours.

148. The method of any one of claims 118 to 147, further comprising recovering the gold-containing complex by adsorption on an absorbent.

149. The method of claim 148, wherein the absorbent is activated carbon or resin beads.

150. The method of claim 148 or 149, further comprising desorbing gold from the absorbent.

151. The method of any one of claims 118 to 150, wherein the comminuting step is performed without using an external heat source.

152. The method of any one of claims 118 to 151, wherein the comminuting step is performed by ball milling or stirred milling.

153. The method of any one of claims 118 to 152, wherein the refractory gold ore concentrate particles have a diameter in the range of from about 1 μm to about 300 μm, or from about 1 μm to about 100 μm, or from about 1 μm to about 75 μm, or from about 1 μm to about 60 μm, or from about 1 μm to about 50 μm, or from about 1 μm to about 40 μm, or from about 1 μm to about 30 μm, or from about 1 μm to about 25 μm.

154. The method of any one of claims 118 to 153, further comprising adding water to the refractory gold ore to obtain a refractory gold ore pulp or slurry.

155. The method of any one of claims 118 to 154, further comprising adding water to the gold-unlocked solid residue to obtain a gold-unlocked solid residue pulp or slurry.

156. The method of any one of claims 118 to 155, further comprising recycling at least a portion of the alkaline reagent.

157. The method of any one of claims 118 to 156, further comprising recycling at least a portion of the gold complexing agent.

158. A method for recovering gold from a refractory gold ore including sulfide mineral or an arsenic sulfide mineral, the method comprising the steps of:
contacting the refractory gold ore with a metal hydroxide added in an amount of hydroxide up to about 4 equivalents per equivalent of sulfur contained in the refractory gold ore;
leaching the refractory gold ore with the metal hydroxide under atmospheric pressure, at a temperature in the range of from about 40° C. to about 80° C. and in the presence of an oxidant added at a flow rate inferior to about 144 L/h/kg to produce at least one metal thiosulfate and obtain a refractory gold ore mixture including a gold-containing leachate and a gold-unlocked solid residue;
mixing at least the gold-unlocked solid residue with a gold complexing agent to form a soluble gold-containing complex; and
recovering gold from the gold-containing complex.

159. The method of claim 158, further comprising separating the gold-containing leachate from the gold-unlocked solid residue.

160. The method of claim 159, wherein separating the gold-containing leachate from the gold-unlocked solid residue is performed by a solid-liquid separation process.

161. The method of any one of claims 158 to 160, further comprising mixing at least the gold-containing leachate with the cyanide complexing agent.

162. The method of any one of claims 158 to 161, wherein the refractory gold ore includes a sulfide mineral or an arsenic sulfide mineral selected from the group consisting of arsenopyrite, pyrite, tetrahedrite, pyrrhotite, marcasite, chalcopyrite, stibnite, and a combination of at least two thereof.

163. The method of any one of claims 158 to 162, wherein the metal of the metal hydroxide is selected from the group consisting of alkali metals and alkaline earth metals.

164. The method of any one of claims 158 to 163, wherein the metal hydroxide is sodium hydroxide or calcium hydroxide.

165. The method of any one of claims 158 to 164, wherein the amount of hydroxide is in the range of from about 1 equivalent to about 4 equivalents, or from about 1 equivalent to about 3 equivalents, or from about 1.5 equivalents to about 2.5 equivalents per equivalent of sulfur contained in the refractory gold ore.

166. The method of claim 165, wherein the amount of hydroxide is about 2 equivalents per equivalent of sulfur contained in the refractory gold ore.

167. The method of any one of claims 158 to 166, wherein the oxidant is selected from the group consisting of air, oxygen, ozone, peroxide, iron oxide, perchlorates, and a mixture of at least two thereof.

168. The method of claim 167, wherein the oxidant is oxygen.

169. The method of any one of claims 158 to 168, wherein the oxidant is added at a flow rate inferior to about 132 L/h/kg, or inferior to about 120 L/h/kg, or inferior to about 108 L/h/kg, or inferior to about 96 L/h/kg, or inferior to about 84 L/h/kg, or inferior to about 72 L/h/kg, or inferior to about 60 L/h/kg, or inferior to about 48 L/h/kg.

170. The method of claim 169, wherein the oxidant is added at a flow rate inferior to about 48 L/h/kg.

171. The method of any one of claims 158 to 170, wherein the leaching step is carried out at a temperature in the range of from about 45° C. to about 75° C., or from about 50° C. to about 70° C., or from about 55° C. to about 65° C.

172. The method of any one of claims 158 to 171, wherein the leaching step is carried out for a time period in the range of from about 8 hours to about 96 hours.

173. The method of any one of claims 158 to 172, wherein the refractory gold ore mixture has a pH in the range of from about 8 to about 14.

174. The method of any one of claims 158 to 173, wherein the refractory gold ore mixture has a solid content in the range of from about 25 wt. % to about 60 wt. %.

175. The method of any one of claims 158 to 174, wherein the gold-unlocked solid residue has a percentage of solid in the range of from about 35 wt. % to about 85 wt. %, or from about 40 wt. % to about 85 wt. %, or from 50 wt. % to about 85 wt. %, or from about 60 wt. % to about 85 wt. %, or from about 70 wt. % to about 85 wt. %.

176. The method of any one of claims 158 to 175, further comprising adding a surfactant to refractory gold ore mixture or to the gold-unlocked solid residue prior to the mixing step.

177. The method of any one of claims 158 to 176, wherein the gold complexing agent is selected from the group consisting of cyanide salts, thiocyanate salts, thiourea salts, thiocyanate salts, ammonium salts, halide salts, and a combination of at least two thereof.

178. The method of claim 177, wherein the gold complexing agent is a cyanide salt selected from the group consisting of sodium cyanide, potassium cyanide, and calcium cyanide.

179. The method of claim 178, wherein the cyanide salt is sodium cyanide.

180. The method of any one of claims 158 to 179, wherein the mixing step is carried out for a period of time in the range of from about 8 hours to about 96 hours.

181. The method of any one of claims 158 to 180, further comprising recovering the gold-containing complex by adsorption on an absorbent.

182. The method of claim 181, wherein the absorbent is activated carbon or resin beads.

183. The method of claim 181 or 182, further comprising desorbing gold from the absorbent.

184. The method of any one of claims 158 to 183, wherein the comminuting step is performed without using an external heat source.

185. The method of any one of claims 158 to 184, wherein the comminuting step is performed by ball milling or stirred milling.

186. The method of any one of claims 158 to 185, wherein the refractory gold ore concentrate particles have a diameter in the range of from about 1 μm to about 300 μm, or from about 1 μm to about 100 μm, or from about 1 μm to about 75 μm, or from about 1 μm to about 60 μm, or from about 1 μm to about 50 μm, or from about 1 μm to about 40 μm, or from about 1 μm to about 30 μm, or from about 1 μm to about 25 μm.

187. The method of any one of claims 158 to 186, further comprising adding water to the refractory gold ore to obtain a refractory gold ore pulp or slurry.

188. The method of any one of claims 158 to 187, further comprising adding water to the gold-unlocked solid residue to obtain a gold-unlocked solid residue pulp or slurry.

189. The method of any one of claims 158 to 188, further comprising recycling at least a portion of the alkaline reagent.

190. The method of any one of claims 158 to 189, further comprising recycling at least a portion of the gold complexing agent.
